(19) United States
(12) Patent Application Publication
(10) Pub. No.: US 2007/0286220 A1
(43) Pub. Date: Dec. 13, 2007

(54) Queue Management System and Method

(76) Inventor: Norman Victor Stenning, Hanta (GB)

Correspondence Address: Andrus, Sceales, Starke & Sawall, 100 East Wisconsin Avenue, Suite 1100, Milwaukee, WI, 53202-4178, US

(21) Appl. No.: 10/585,697

(22) PCT Filed: Jun. 14, 2005
(86) PCT No.: PCT/GB05/02341

§ 371 Date: Aug. 13, 2007

(30) Foreign Application Priority Data
Jun. 17, 2004 (GB) 0413624.8

(51) Int. Cl. H04L 12/28

(52) U.S. Cl. 370/412

(57) ABSTRACT

The invention provides a queue management system and method for controlling the movement of a group of one or more people through a virtual queue line for a service. The system comprises registration means (50) for registering the group, the registration means comprising an information carrier (52) bearing a registration code and at least one ID tag (54) including ID details for the member(s) of the group. The registration means associates the registration code with an indication of group size and uniquely with the ID details. The system further comprises interface means (48) for enabling communications to and from the group, and a processor (32, 34) associated with the interface means and responsive to a communication from the group including a communicator address and the registration code for generating a registration record for the group representing the group size, the ID details and the communicator address. The processor is arranged to receive a communication from the group requesting access to the virtual queue and to monitor the place of the group in the queue line and then trigger a summons signal when the group approaches or reaches the head of the queue line. The interface means is responsive to the summons signal for initiating a communication to the communicator address for summoning the group to the service. Access control apparatus (22) at the service reads the at least one ID tag and compares the ID details with the registration record in order to evaluate whether access to the service should be permitted or prevented.

### BACKGROUND OF THE INVENTION

1. Field of the Invention

The present invention relates to a system and method for managing or controlling queues of people. More particularly, the invention relates to a virtual queuing arrangement, in which people using the queue are not constrained to stand in a physical line in order to maintain their place but rather have their place established and maintained automatically while they themselves may be physically elsewhere.

2. Prior Art

In many situations, such as when visiting a theme park or when attending an out-patients department of a hospital, people are typically required to join a physical queue in order to obtain a given service. Often the required queuing time can be substantial. During this time, the people in the queue are constrained to remain in a particular physical location and are not free to move around or engage in other activities. As is well known, these queues may be unpopular and a source of considerable irritation for those forced to suffer them. Further, as a significant source of customer dissatisfaction, they may also be unpopular with service operators. For example, long queues at theme parks can have a direct economic impact, by discouraging people from attending or returning, while queues at outpatients departments may exacerbate the problems of antisocial behaviour and violence towards staff.

The problem has been addressed in the prior art by the development of virtual queuing systems. With such a system, a person wishing to queue for a service is not forced to join a physical line but rather has the option of joining a virtual queue that operates in parallel with, or in place of, the physical queue. The system then tracks the person's progress and provides some form of indication when the person has reached the head of the combined or virtual queue and is now entitled to obtain the service. Thus, by recording the time of joining the queue and subsequently tracking progress, the system eliminates the need for its users physically to remain in line.

A simple example of a virtual queuing system is provided by the well-known sequence number ticket system used in some shops, post offices and the like. With this system, a person wishing to join the queue takes a numbered ticket from a dispenser. These tickets are numbered in ascending order and each ticket indicates the holder's place in the queue. There is a large display that shows the number currently at the head of the queue. By comparing the number shown on this display with the number on their own ticket, each individual is able to determine the number of people ahead of them in the queue and, ultimately, that they themselves have reached the head of the queue. Such a system therefore eliminates the need to stand in an ordered line. However, since the display typically has a very limited range of visibility, people must either remain in close physical proximity to the display or risk losing their place. Thus, such systems do not allow their users to move around freely and engage in other activities.

More advanced virtual queuing systems fall into two broad classes: timeslot ticket systems as disclosed, for example, in U.S. Pat. No. 6,173,209; and short range radio systems as disclosed, for example, in U.S. Pat. No. 5,987,421 and US2003093167.

Timeslot ticket systems are similar to sequence number ticket systems except that rather than specifying a sequence number, the issued ticket specifies a timeslot—such as 14h00 to 14h30—during which the holder will be granted near-immediate access to the service. This predetermined timeslot eliminates the need to remain in sight of a display, thus freeing the ticket holder to move around and engage in other activities. However, these systems have two significant disadvantages. First, they are subject to disruption when there is substantial unplanned variation in the throughput of the service—as might arise, for example, with the breakdown of a ride at an amusement park. Under such circumstances, timeslot ticket systems exacerbate the queue management problem, since people hold timeslot tickets that cannot now be honoured and these ticket holders are often competing with people who have had an extended wait in the physical queue. Second, in practice they often necessitate secondary queuing. Since the system must impose various checks and constraints in order to prevent abuse, the issuing of each ticket is not an entirely trivial action and typically takes many seconds. Consequently, queues can form at the locations that issue the tickets. Reports from organisations that have implemented timeslot ticket systems suggest that, at busy periods, the wait in these secondary queues can be half an hour or more.

Short range radio systems offer greater resilience against major variations in service throughput. Users of such a system carry some form of specialised short range radio communicator able to receive communications from a virtual queue control computer. Rather than assigning a fixed timeslot at the time a person joins the virtual queue, the computer dynamically tracks progress through the queue and then sends a message once the person reaches the head of the queue. Any degradation in service throughput causes a longer wait in the queue, but does not cause disruption.

A particular example of such a system is described in US 2003/0102956 and comprises an arrangement in which customers arriving at the admission barrier of a theme park are each issued with a unique entry token and, if requested, a portable communications device for logging-in to attractions. When the customer having such a portable communications device has reached the front of a combined physical and virtual queue for the attraction, the theme park computer issues a summons to the attraction. Entry to the attraction is then monitored by means of the entry tokens.

While they avoid the disruption problem, short range radio systems do not eliminate secondary queuing. Since there is a potential problem of non-return, the issuing of a communicator to a person wishing to use the system is a non-trivial action that entails various checks and probably some form of deposit. As a consequence, queues can form at the communicator issuing stations, and at busy periods the waiting time in these secondary queues can be half an hour or more.

In hospital and other health-related applications, short range radio systems suffer from a further problem. A communicator that has been used by one person is subsequently re-used by some other person, but as small electronic devices the communicators are not well suited for sterilisation.

### SUMMARY OF THE INVENTION

The present invention seeks to provide a virtual queuing system and method that eliminates the disadvantages of the existing timeslot ticket and short range radio systems.

The invention also seeks to avoid the need for specialised hardware, such as that needed to support a short-range radio network. In this way, the invention aims to reduce or eliminate the reliability and maintenance problems associated with such specialist hardware.

The invention provides a virtual queuing system for use at locations (e.g. theme parks) that offer one or more services (e.g. rides). Virtual queuing may be supported for some or all the services at a location.

According to one aspect of the present invention, there is provided a queue management system for controlling the movement of a group of one or more people through a virtual queue line for a service, comprising:
registration means for registering the group, the registration means comprising an information carrier and at least one ID tag for the member(s) of the group, the information carrier bearing a registration code and the at least one ID tag including ID details for identifying the member(s) of the group, the registration means further associating the registration code with an indication of group size and uniquely with the ID details;
interface means for enabling communications to and from the group;
a processor associated with the interface means and responsive to a communication from the group including a communicator address and the registration code for generating a registration record for the group representing the group size, the ID details and the communicator address;
the processor being arranged to receive a communication from the group requesting access to the virtual queue and to monitor the place of the group in the queue line and to trigger a summons signal when the group approaches or reaches the head of the queue line;
the interface means being responsive to the summons signal for initiating a communication to the communicator address for summoning the group to the service; and
access control apparatus at the service for reading the at least one ID tag and for comparing the ID details with the registration record in order to evaluate whether access to the service should be permitted or prevented.

According to another aspect of the present invention, there is provided a method of queue management for controlling the movement of a group of one or more people through a virtual queue line for a service, comprising the steps of:
assigning to the group an information carrier and at least one ID tag for the member(s) of the group, the information carrier bearing a registration code and the at least one ID tag including ID details for identifying the member(s) of the group;
associating the registration code with an indication of group size and uniquely with the ID details;
in response to a communication from the group including a communicator address and the registration code, registering the group by generating a registration record for the group representing the group size, the ID details and the communicator address;
in response to a request from the group for access to the virtual queue, assigning the group a place in the queue line and monitoring the place of the group in the queue line and triggering a summons signal when the group approaches or reaches the head of the queue line;
in response to the summons signal, initiating a communication to the communicator address for summoning the group to the service; and
at the service, reading the at least one ID tag and comparing the ID details with the registration record in order to evaluate whether access to the service should be permitted or prevented.

An advantage of the invention is that it avoids any need for secondary queuing, and it does not entail providing users with a specialised electronic device, since it may be implemented through the use of personal identification tags in combination with the user's own mobile telephone or other such device.

Another advantage of the invention is that it is resilient against substantial unplanned variations in service throughput.

In a simple case, the invention covers the situation where a single individual queues for just a single service. In a preferred embodiment, however, When invention encompasses the situation in which a group of people (such as a family group) wishes to avail itself of a series of services at a given location (such as various rides at a theme park).

Typically, each such service may have both a virtual queue and a conventional physical queue. In this case, the physical and virtual queues operate in parallel, and indeed could legitimately be regarded as just two distinguished portions of one single queue. The service may thus be accessed through either the physical or the virtual queue. The main distinction is that people in the physical queue are constrained to wait in a line while those in the virtual queue are free to move around or engage in other activities. Alternatively, however, the operator of the location or service may choose to eliminate physical queuing for a service, so that all visitors who wish to use the service are obliged to use the virtual queuing system.

The virtual queuing system permits groups of individuals (such as families) to move around the location and queue for services as a group rather than as separate individuals. A group may be one person or more. According to the invention, each group has its own mobile phone or personal communicator that is used for bi-directional communication with the virtual queuing system.

In the preferred embodiment described below, the virtual queuing system maintains an itinerary for each group, showing a sequence of one or more services that the group wishes to use. As the group completes its use of each service, so the virtual queuing system enters the group into the virtual queue for the next service in their itinerary. The system then tracks the group's progress through the queue and, on their reaching the head of the queue, calls the group to the service by a communication to their mobile phone. Subsequently, when members of the group arrive at the place at which the service is delivered, the system grants them near-immediate access via a virtual queue priority access point.

The virtual queuing system preferably consists of:
A virtual queue management system, which is a computer system (consisting of one or more physical computers) that maintains in its memory full information on the virtual queues at the location. For example, this computer system records the entry of a group into the virtual queue for a service, tracks the progress of the group through the queue, detects the group's reaching the head of the queue, calls the group to the service by communicating through the group's mobile phone, and performs right of entry checks when the group arrives at the priority access point for the service.
Interfacing equipment through which the computer system interfaces to the mobile telephone networks and hence can communicate with the mobile phones carried by groups using the virtual queuing system.
Personal identification tags held by each member of each group using the virtual queuing system. The tag held by a given individual identifies that person as being a member of a group known to the queuing system, and is used by that individual to gain entry at service priority access points.
An identification and access control mechanism at each service priority access point, directly or indirectly interfaced to the queue management computer system. When an individual arrives at the priority access point and claims entry, this identification mechanism communicates the value of the individual's identification tag to the computer system, which responds with an indication of whether that individual is to be permitted access or denied access.

Broadly, the operation of the virtual queuing system according to the preferred embodiment is as follows:
1. A group that wishes to use the virtual queuing system obtains its registration code and identification tags.
2. The system registers the group. Through this registration, the system establishes:
that there is a new group wishing to use the virtual queuing system
the size of this group (i.e. number of persons, from one upwards)
the full telephone number of the mobile phone through which the group and the system will communicate
some form of association between the value(s) of the tags held by individual group members and the group itself; these associations are such that, given any tag value, the system can determine the group to which the individual holding that tag belongs.
3. The system either retrieves a previously-created itinerary for the group or establishes a new itinerary for the group. In either case, this itinerary shows a sequence of one or more services that the group wishes to use.
4. The system adds the group to the end of the virtual queue for the first service in the group's itinerary. This virtual queue is maintained in the system's memory.
5. Using information on the throughput rate of the service, the system tracks the group's progress through the virtual queue.
6. When the group reaches the head of the queue, the system sends a communication to the group's mobile phone indicating that the group should now go to the service.
7. As group members arrive at the service priority access point, either together or individually, the system checks the value of the tag held by each individual group member. By so doing, the system determines that the individual is indeed a member of a group that has been called to the service (rather than some interloper) and therefore sends an indication to the priority access point that the individual should be granted access.
8. Having recorded the arrival times of group members at the service, and using stored information on the total time taken to use the service, the system calculates the time at which the group will leave this service. At that time, the system adds the group to the virtual queue for the next service in their itinerary.

The invention thus entails bidirectional communication between the queuing system and the holder of the group's personal communicator or mobile phone. Depending on the particular embodiment, this communication may take any of several forms, or a combination of these forms. For example, communication from the mobile phone holder to the system could be through sending a text message or through making a voice call to an Interactive Voice Response (IVR) sub-system that forms part of the overall queue management system. In the latter case, the phone holder responds to voice prompts from the system by keying on the mobile phone keypad or by speaking words to a voice recognition system. Communication from the system to the mobile phone holder could be in the form of text messages. Alternatively, the system could include an IVR sub-system that produces either pre-recorded or synthesised voice messages.

Each member of each group using the virtual queuing system conveniently carries a personal identification tag. This tag serves only to identify a person as a member of a given group when that person claims access at a service priority access point. People who are not using the virtual queuing system (i.e. who wait in the physical queues) do not require identification tags. The tag has a value. This value is read by the identification mechanism at a service priority access point and communicated to the queue management system. The queue management system uses this tag value to determine whether the holder is a member of a group that the system has previously called to the service (upon the group reaching the head of the queue) and should therefore be granted entry at the service priority access point.

In one embodiment, the tags held by the different members of a given group all share one common value. In an alternative embodiment, the tag values of the various group members may differ. In either case the queue management system maintains some form of association between the various tag values and the group, sufficient to allow the system to compute from any individual tag value the group to which that tag holder belongs.

The various tag values are essentially unique. In some embodiments the values may be truly unique, formed for example by encoding both the date and a unique number within that date. In other embodiments, values may be re-used, but the time period and context of re-use will be such as to avoid any possible confusion between the separate uses.

Advantageously, the tags are designed so that they cannot readily be forged.

Tags and the associated identification mechanisms may take any of a variety of forms. For example:
The tag may be a barcode, perhaps on a wristband worn by the holder, and the identification mechanism a barcode reader
The tag may be a radio frequency identification (RFID) chip, and the identification mechanism an RFID scanner
The tag may be some form of biometric identifier—such as a person's face, retina scan or fingerprint—and the identification mechanism the appropriate form of scanning and recognition system.

Through registration, the system establishes the size of the group, their communicator address (e.g. mobile phone number), and their tag values. The precise details of the registration step depend upon the particular embodiment and, in particular, the type of tags employed in that embodiment.

As one example, tags that take the form of barcodes or RFID chips could be supplied in group registration packs. Such packs are categorised by group size. Each pack contains a tag for each member of the group plus a printed registration code. The registration step is then triggered by a communication from the group's mobile phone to the queue management system. In this communication the group's mobile phone holder provides the registration code from the registration pack. The queue management system obtains the number of the group's mobile phone automatically, either by using the phone network's caller identification facility or, in the case of a text message, from the sender number field. The system then uses the registration code to establish the association between the value(s) of tags held by group members and the group itself. The registration code is specifically formulated to enable the system to make this association. In the simplest case, for example, the registration code may be identical to the common tag value held by all group members, but other more complex encodings are also possible.

As a second example, where biometric tags are employed, registration may entail the group first visiting a tag recognition point. At this point, the group would insert the card containing their registration code into a card reader. The system would read the registration code from the card and then conduct the appropriate scans—of faces, retinas, fingerprints, or other biometric indicators. Subsequently the group makes a registration call from their mobile phone, specifying their registration code, and the system retrieves the mobile phone number using caller identification. The system then has all the information required—group size, mobile phone number and biometric tag values—and can establish the necessary associations.

In order to join a virtual queue, the group establishes an itinerary showing a sequence of one or more services that the group wishes to use. This can be done before, during or after registration.

Dependent upon the particular embodiment, the system may provide various means of itinerary creation. Advantageously, the system would support itinerary creation from the group's mobile phone through the use of various editing commands to add a service to the itinerary, move a service within the itinerary sequence, and so on. Additionally, the system could also support selection from a set of pre-defined ‘suggested itineraries’, each showing a popular sequence of services. Having selected one of these pre-defined itineraries, the mobile phone holder could use the editing commands to tailor the predefined sequence to the group's precise requirements.

Optionally, the system could also support an itinerary creation website. At this website, a user would enter the number of the mobile phone that the group intends to use and create an itinerary, typically by selecting from a graphical ‘map’ of the available services.

Where an itinerary is created prior to registration, the system initially conveniently associates that itinerary with a mobile phone number. Subsequently during registration the system detects that there is a pre-defined itinerary for this particular phone number and can associate that itinerary with the group. Where an itinerary is created either during or after registration, the system may immediately associate the itinerary with the group.

Once a group is registered and has an itinerary, the system adds the group to the end of the virtual queue for the first service in that itinerary.

The system then calculates the time at which the group is expected to reach the head of the virtual queue. One possibility is for the system to maintain a service throughput profile showing, for various time periods, the average throughput rate of the service. For example, this profile might show that between 08h00 and 12h00 the service throughput is 3000 people per hour, that between 12h00 and 14h00 it is 2000 people per hour, and so on. Such variations may be due, for example, to changes in service staffing levels.

The system can then use any of various means for calculating the time required for the group to reach the head of the virtual queue. As two examples:
The system can be equipped with means for determining the total number of people at the location at any given time. Through registration, the system also has accurate information on the number of people using the virtual queuing system. Hence the system can determine the relative proportions of people using physical and virtual queuing. It can therefore allocate the total capacity of each service proportionally to the two queues. It then determines the rate of progress through the virtual queue using just the allocated proportion of the service's overall capacity.
The system can be equipped with the means for continually determining the number of people in the physical queue for each service, within some acceptable bound of accuracy. This can be done, for example, by the system maintaining a physical queue length profile showing the expected length of the physical queue during various periods throughout the day.

This profile could be derived from historical records and may vary with day type—for example, whether a weekday or a weekend, peak or low season, wet or dry, and so on. Further, system operators would be able to adjust this profile based on the observed actual length of the physical queue, so as to maintain acceptable accuracy. When a new group joins the virtual queue, the system can then use the known current length of the virtual queue and the estimated length of the physical queue to determine the group's overall position in the total queue (physical+virtual). Using the service throughput profile, the system can then calculate the time taken for the group to reach the head of the total queue.

Having calculated the time at which the group is expected to reach the head of the queue, the preferred embodiment sends a communication to the group's mobile phone, informing them of this expected call time. Then, when the group reaches the head of the queue, the system sends a second communication, calling the group to the service.

As a refinement, the system may send the summons to the service some short period (e.g. a few minutes) before the group reaches the head of the queue. This period would allow the group some time to reach the service if they are physically some distance away.

On being called to a service, the members of the group make their way to the service and specifically in the preferred embodiment to its priority access point. Only people who are registered users of the virtual queuing system, and therefore have an identification tag, may be permitted to use this priority access point. Anyone without a tag is immediately refused access.

As each individual reports at the priority access point, the access control mechanism at that access point determines the value of that individual's identification tag and sends this value to the queue management system. Using this tag value, the system determines the group to which that individual belongs. If that individual is a member of a group that the system has called to the service, then the system sends a signal back to the access point indicating that access should be granted. However, if the group to which the individual belongs has not been called to the service, then the system sends an indication that access should be denied, possibly with some accompanying explanation for this denial. The system also rejects any attempt to gain access using a tag that is not recognised—a situation that can arise with biometric tags or, for example, if a person attempts to re-use an ‘old’ tag from an earlier day.

The various group members need not be constrained to arrive at the access point as a group. They can arrive separately and be granted access individually. Further, there is no requirement that all group members actually use the service—some or all members may choose to abstain.

In an embodiment where group members hold tags with different values, the system may grant each person access on an individual basis, with each individual being granted access just once (i.e. the same tag cannot be re-presented to allow a second access). In an embodiment where all group members share the same tag value, the system grants access for that value a number of times, up to but not exceeding the total group size.

Optionally, the system can impose a time limit on each call to a service, so that the call only remains valid for some defined time period such as 30 minutes or one hour. Group members are then required to report at the priority access point at any time between the call being issued and expiry of this defined validity period. Any individual arriving after this period will be denied access with the explanation of ‘call expired’. This time limit promotes timely arrival at the service and thereby facilitates orderly queue management.

The system in its preferred form maintains a record of the typical time taken to use each service, from the time of arrival at the priority access point to the time of leaving the service at its exit point. This record is updated by the system operators as necessary, based on observations of actual service transit times. Using this record, the system determines the time at which each group reporting at the service's priority access point will subsequently leave the service. However, where individual group members report to the priority access point at different times, they will also leave the service at different times. Under these circumstances various embodiments could calculate the service exit time based on the arrival time of the first member of the group, or the last member of the group, or the average arrival times of all group members who use the service. In any event, the system calculates just one service exit time for the whole group.

At this calculated service exit time, the system adds the group to the virtual queue for the next service in their itinerary. It then sends a communication to the group's mobile phone with an estimate of the time at which the group will be called to that service.

However, if the service that the group is leaving was the last in their itinerary, the system sends a communication indicating that the group's itinerary is now empty. If the group members wish to continue using the virtual queuing system they must then establish a new itinerary.

As previously stated, the system preferably creates a service throughput profile, which the system uses in calculating the time at which a group is expected to reach the head of the virtual queue for that service. Normally, the service throughput profile shows planned changes in the service throughput rate—for example, a reduction in throughput during periods when the service has fewer staff. However, there can also be unplanned changes in throughput rate, most notably in cases of service breakdown when the throughput temporarily drops to zero. Such unplanned changes in throughput rate of course impact the rate at which the queue progresses, and therefore impact the time at which a group in the queue should be called to the service.

Where the throughput rate changes unexpectedly, that change must first be detected, either by the location or service staff or by some automated means of detection. The change must then be input to the system, either by a system operator or by automated input. This input takes the form of an edit to the service throughput profile to reflect the new situation. For example, in case of a service breakdown that is expected to take one hour to fix, the profile would be edited to show a throughput of zero over the next hour, followed by a resumption of the originally planned throughput rate. Or if the problem is expected to degrade the throughput rate for the remainder of the day, the profile would be edited to show that degraded rate.

Whenever a service throughput profile is edited, the system re-calculates the expected call time for all groups in the virtual queue for that service. Note that, rather than always extending the waiting time in the virtual queue, some edits to the throughput profile could reduce the waiting time—for example, in the case where the time required to fix a breakdown turns out to be shorter than originally expected and the profile is then edited to reflect that shorter time. Having re-calculated new expected call times for each group in the virtual queue, the system can then take appropriate action for each group. For example:
where the change in expected call time is insignificant, the system need do nothing
where the change in expected call time is significant, the system can send a communication to the group's mobile phone informing them of the new expected call time
where the waiting time will now be substantial, the system can offer the group various options—continue to wait, move this service down the group's itinerary to a later position in the sequence, or cancel this service and remove it from the itinerary.

For groups that are newly joining the virtual queue for the service, no special action is required. The system simply calculates the expected call time in the usual way, using the edited service throughput profile, and this calculated time of course reflects the unplanned change in throughput rate.

### BRIEF DESCRIPTION OF THE DRAWINGS

The invention will now be described further, by way of example, with reference to the accompanying drawings, in which:

FIG. 1 shows a location with entrances, services and itinerary management stations;

FIG. 2 is a schematic illustration of a single service at the location, showing the service, its physical queue, and a priority access point for a virtual queue;

FIG. 3 is a block diagram of a queue management system according to the invention;

FIG. 4 shows the contents of a registration pack;

FIG. 5 is a flowchart showing the registration of a group;

FIG. 6 is a flowchart showing the system's actions when an itinerary is edited;

FIG. 7 is a flowchart showing the actions of the system whenever a group is ready to be added to the virtual queue for the next service in their itinerary;

FIG. 8 is a flowchart showing how the system progresses the virtual queue for a service and calls groups to the service;

FIG. 9 is a flowchart showing the system's actions when an individual claims access at a service priority access point;

FIG. 10 is a flowchart showing the actions taken by the system whenever a service throughput profile is edited;

FIG. 11 is a flowchart showing how the system processes a pause item in an itinerary;

FIG. 12 is a flowchart showing how the system progresses a pause queue;

FIG. 13 is a refinement of FIG. 10, and is a flowchart showing the actions taken by the system whenever a service throughput profile is edited and the pause itinerary option is supported;

FIG. 14 is a refinement of FIG. 8, and is a flowchart showing how the system progresses a virtual queue when applying a no-show factor;

FIG. 15 is a block diagram of the computer system at the heart of the registration pack production system;

FIG. 16 shows a location with tag recognition points;

FIG. 17 is a block diagram of a tag recognition point and its interface with a local area network at the location;

FIG. 18 is a flowchart showing the system's identification tag recognition procedure in a second embodiment of the invention; and

FIG. 19 is a flowchart showing group registration in the second embodiment.

### DETAILED DESCRIPTION OF SPECIFIC EMBODIMENTS

The invention can have various alternative embodiments. An embodiment in which personal identification tags take the form of wristbands with barcodes will be described first. A second embodiment in which personal identification tags could be based on biometric identification will then be described. Finally, some illustrative alternative embodiments that essentially are variants of either the first or second embodiment will be described. Given these descriptions, a wide range of possible embodiments will be obvious to those skilled in the art, as will variants on those embodiments that include or exclude specific features.

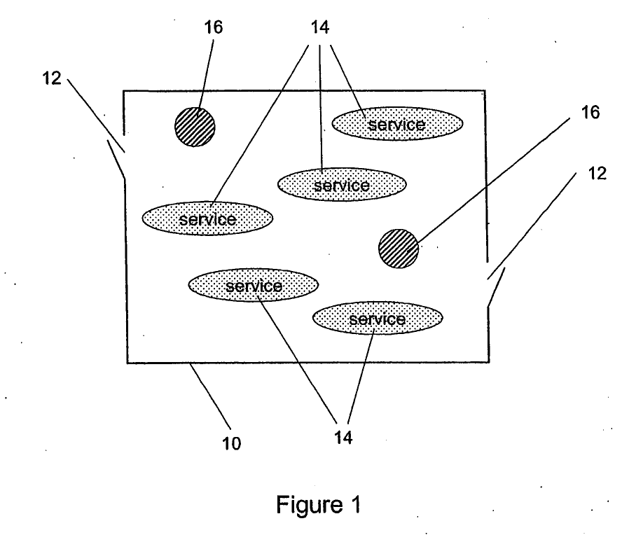

As shown in FIG. 1, a location typically has a perimeter 10 and one or more entrances 12. The location features a number of services 14. Optionally, the location may also provide one or more itinerary management stations 16 at which users of the virtual queuing system according to the invention can view and edit their itineraries.

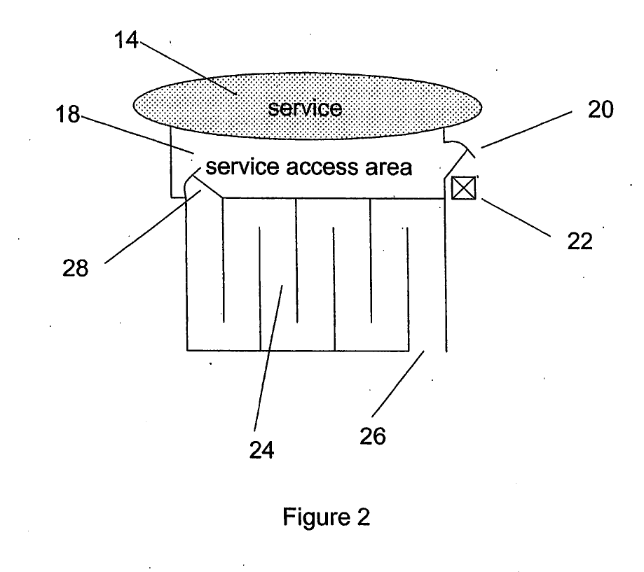

FIG. 2 provides a more detailed view of a single service for which virtual queuing is supported. The service 14 has a service access area 18 from which people can gain direct access to the service. There is a priority access point 20 at which members of groups who have reached the head of the virtual queue for the service can gain immediate entry to the service access area. In order to do so, they present their personal identification tags to access control apparatus such as an identification and access control mechanism 22. The service also has a physical queue line 24 with its own entry point 26 and a flow control point 28 at the head of the queue that controls entry to the service access area. This flow control point may be manually controlled by service staff, or could be under automated control. The virtual queuing system calls group members to the priority access point as they reach the head of the virtual queue. However, these people from the virtual queue will consume only part of the available service throughput. People waiting in the physical queue are then allowed through its flow control point at the appropriate rate to consume the remaining part of the service throughput. For example, where the service is provided on an individual basis, one person will be allowed to pass through the flow control point whenever a service ‘slot’ becomes free that is not consumed by a person from the virtual queue. Or in the case of an amusement park, where the service might take the form of a train with a number of cars, sufficient people will be allowed through the flow control point so that, with the people from the virtual queue who come through the priority access point, each train is just filled. Thus the service capacity is shared fairly between people from the physical queue and people from the virtual queue, with comparable queuing times in each.

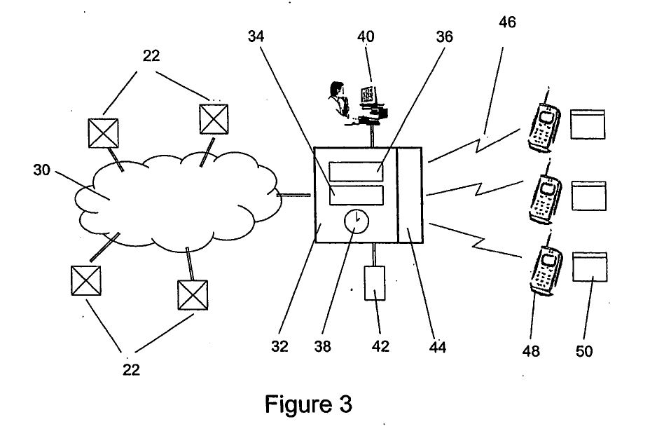

The virtual queuing system of the invention is shown in FIG. 3. At its heart is a virtual queue management system computer 32 that is interfaced through an industry-standard local area network 30 to the identification and access control mechanism 22 at each service for which virtual queuing is supported. The virtual queue management system computer includes a central processing unit 34, memory 36 and a system clock 38. It also has an operator station 40 at which operators can interact with the computer system and a CD drive 42 for reading standard CDs. It further has interface means 44 for communicating with groups using the virtual queuing system. Via this interface means, the computer system can send and receive communications 46 to and from communicators such as mobile telephones 48 carried respectively by each group using the virtual queuing system.

Personal Identification Tags and Registration Packs

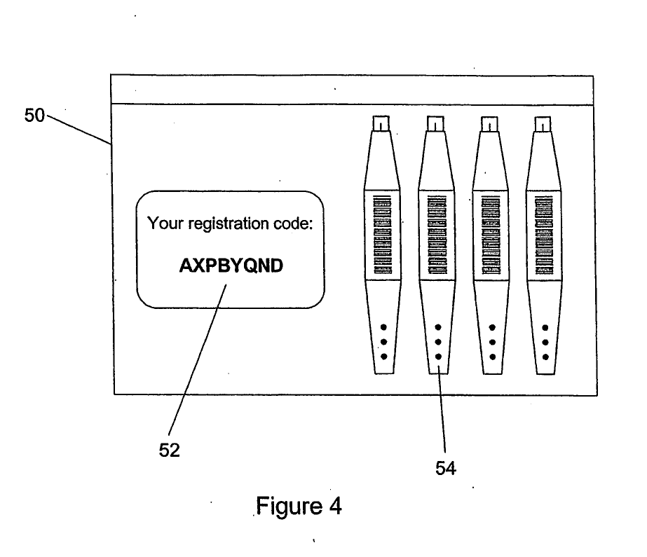

A group of people wishing to use the virtual queuing system at the location must first possess a mobile telephone 48. The group must then obtain a registration pack 50 as shown in FIG. 4. Depending on whether the location operator wishes to charge for use of the queuing system, the group may simply be given this pack on request or may be required to purchase the pack.

A group would normally obtain its registration pack immediately on arrival at one of the entrances 12 to the location or shortly thereafter. For example, if the location requires entry tickets and has entry points with booths that sell these tickets, then those booths would also provide registration packs to those groups that request them. Additionally, in the case of an amusement park that has retail outlets within the park, some of those outlets may supply registration packs in addition to their other merchandise. Or there could be booths within the park dedicated to the provision of registration packs.

The provision of a registration pack is a straightforward transaction, requiring only the handover of the pack and perhaps some payment (which might be combined with payment for the location entry ticket). Further, at any given location there can be many places that provide the registration packs, including all the location entrances 12 and other places such as retail outlets or itinerary management stations 16 within the location. Consequently, a group can obtain its registration pack without any need for secondary queuing.

Registration packs are categorised by size of group—there are packs for single-person groups, packs for groups of two, packs of groups of three, and so on. There is a maximum group size that the services at the location are prepared to accommodate. At an amusement park, for example, that maximum group size might be six. Registration packs will be available for any group size from one to this maximum.

As shown in FIG. 4, the registration pack 50 contains an information carrier such as a registration card 52 with a printed registration code. It also contains ID tags 54, which in this embodiment are personal identification tags in the form of wristbands with barcodes, with one such identification tag being provided for each group member. So, for example, a registration pack for a group of four would contain four wristbands. Each wristband includes a printed barcode, which provides an ID value that unambiguously identifies the individual wearing the wristband as a member of this particular group.

The registration code is essentially unique, generated by any algorithm capable of producing random (or pseudo-random) codes that are non-repeating over a period of; say, one year or more. At the time of generation, each code is assigned to one specific group size so that the system is subsequently able to determine, from a given code, the size of the group to which that code belongs.

The registration code is such that (i) even an intelligent observer who is well-versed in the design and operation of the virtual queuing system would not be able to deduce the codes that are valid at a given location on a given date; and (ii) any attempt at guessing such a valid code would have a very small probability of success [such as a probability of less than one in a million]. These properties are achieved through use of random codes of a length that accommodates, say, one billion different combinations or more.

In order to facilitate entry of the registration code into the system through the use of a mobile phone keypad, it is desirable (though not essential) for the code to consist solely of a sequence of alphanumeric characters. Given this, plus the requirement for a billion or more possible combinations, it is appropriate for the code to consist of a sequence of, say, eight letters. Thus a registration code could be the sequence AXPBYQND.

To prevent abuse of the system, whereby a single group could be in two or more virtual queues at the same time, it is desirable to ensure that each group can only obtain a single registration pack. Where the location provides entrance tickets, this can be achieved by marking tickets in some way to indicate that a pack has been supplied. Alternatively, the location can be physically organised in such a way that each group is given just a single opportunity to obtain a registration pack, for example at a point of entry.

Registration

Having obtained a registration pack 50, the group must then register with the queuing system. This registration step is triggered by a communication from the group's mobile phone to the queue management system computer 32. In this communication, the group's mobile phone holder sends to the queue management system the registration code from the group's registration card—either as the content of a text message or by keying the code in on the phone's keypad in response to a prompt from the computer 32.

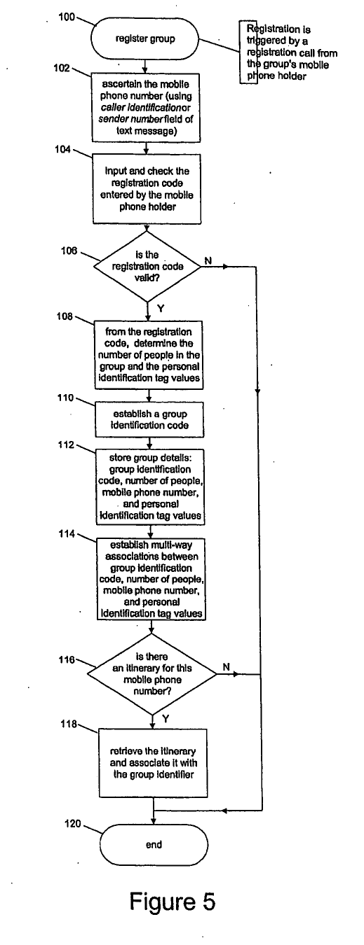

The procedure whereby the queuing system registers a group is illustrated in the flowchart of FIG. 5. While some of the procedures shown in the flowcharts are triggered by the actions of groups using the queuing system—such as a registration communication or arrival at a service priority access point—the procedures themselves are performed entirely by the processor 34 within the virtual queue management system computer 32. Further, except where explicitly stated otherwise in the detailed description below, each step shown in the flowcharts employs only information held in the computer's memory 36.

As shown in FIG. 5, at step 102 the queue management system computer 32 first ascertains the number of the mobile phone that the group is using, either through the phone network's caller identification facility or from the sender number field of the text message.

At step 104 the computer 32 inputs and checks the registration code entered on the group's mobile phone. At step 106 the computer checks whether the code'is valid. A valid code indicates that the group has obtained a registration pack and is therefore entitled to use the queuing system, but any attempt to register with an invalid code is simply ignored, as shown by the N branch from step 106.

At step 108 the computer 32 determines from the registration code:
the number of people in the group
the values of the personal identification tags held by each group member. In this first embodiment these values are all the same, and are the same as the group registration code.

At step 110 the computer 32 establishes an identification code for the group. This code is used for identifying the group internally within the computer itself, and must be unique for the location and the day. Since the registration code already has these properties, it could be used for this purpose, and that indeed is one option. However, since it must allow a very large number of possible combinations and include a substantial random element, the registration code is not the most convenient form of identifier for use within the computer. Consequently, in this first embodiment, the computer assigns its own group identification code by means of sequential numbering. Thus it assigns the number 1 to the first group that registers during the day, the number 2 to the second group, and so on.

At steps 112 and 114 the computer 32 establishes a registration record for the group. Specifically, the computer stores in its memory 36, and establishes multi-way associations between, the various group details from steps 104 through 110:
the group identification code
the size of the group
the group's mobile phone number
the values of the personal identification tags of the group members.

Where the group registration code may be required for later use—for example, where the system supports itinerary management stations as described below—the computer also stores the registration code in its memory and establishes a two-way association with the group identification code.

Establishing these various associations is the essence of the registration step. From these associations, the computer will subsequently be able to map from any given information about the group to any other information. For example, from a group identification code the computer can determine the number of the group's mobile phone—or vice versa. Or from a personal identification tag value the computer can determine the group to which the individual holding that tag belongs.

Having stored the group's details and established the multi-way associations, the computer 32 checks at step 116 whether there is already an itinerary stored in its memory 36 for the group's mobile phone number. If so, at step 118 the computer retrieves that stored itinerary and associates it with the group identification code.

Establishing an Itinerary

In order to join virtual queues, the group must have an itinerary. Such an itinerary shows the sequence of one or more services 14 that the group wishes to use.

Following registration, a group can establish an itinerary from their mobile phone. The simplest way of establishing a full itinerary is by selecting from a set of suggested itineraries that the location might publicise through signs and leaflets. Each such suggested itinerary features a particular sequence of services and there might be, say, six suggested itineraries from which to choose. The group selects one of these suggested itineraries by sending a communication from their mobile phone to the computer 32 specifying their choice.

Using their mobile phone, the group can also view their current itinerary—which the system presents by sending back a text message or by synthesising a voice message—or edit their itinerary using commands to add a service at a particular point in the itinerary, delete a service, move a service, and so on.

By selecting one of the suggested itineraries and then editing it as appropriate, the group can create a custom itinerary that matches their exact requirements. Alternatively, by using editing commands alone—and particularly the ‘add service’ command—the group can create an itinerary ‘from scratch’.

In the present instance, itineraries can also be created or changed using the itinerary management stations 16 within the location. Just as with the mobile phone interface, each such management station 16 provides facilities to select a suggested itinerary, edit the current itinerary and view the current itinerary. The management stations 16 conveniently each have graphical display, perhaps based on a stylised map of the location, and support simple ‘point and click’ interaction. To use such an itinerary management station 16, the group simply logs in using their registration code.

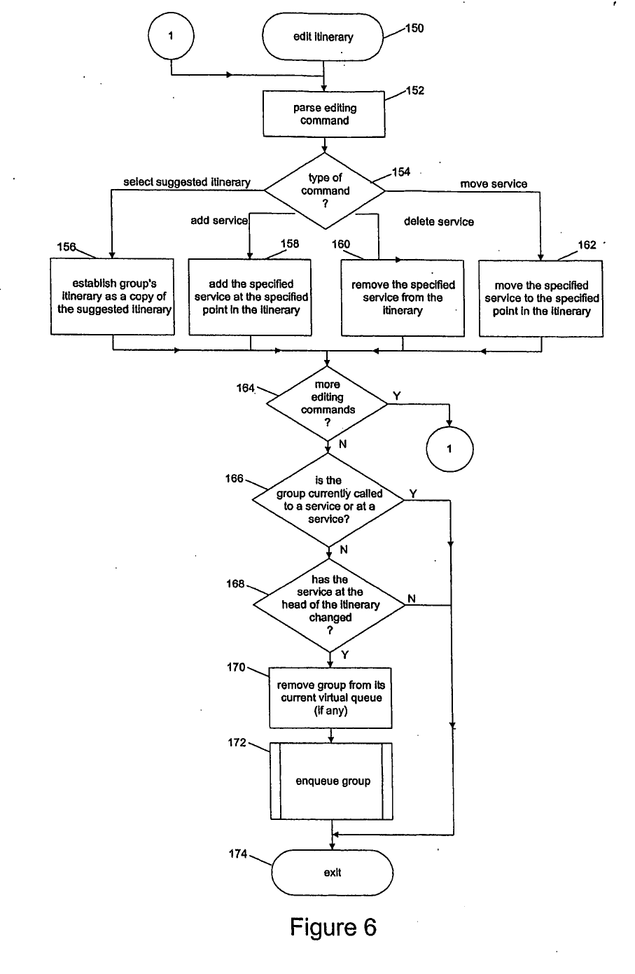

The system's processing of itinerary selection and editing commands is shown in the flowchart of FIG. 6.

The procedure shown in the flowchart is triggered whenever the group submits one or more commands to edit its itinerary, whether from their mobile phone or from an itinerary management station 16. The procedure supports the processing of a sequence of one or more editing commands, since a single text message from the group's mobile phone could contain several commands rather than just one.

At step 152 the queue management system computer 32 parses the first editing command or, on subsequent iterations, the next command in the sequence. At step 154 the computer then determines the type of command—whether it is to select one of the suggested itineraries, to add a service to the current itinerary, delete a service, or move a service from one position to another within the itinerary. Depending on the type of command, the computer then takes the appropriate action to modify the itinerary at step 156, 158, 160 or 162.

At step 164 the computer 32 tests whether there are more editing commands to be processed. If so, it returns to step 152 to parse and process the next command.

When the complete sequence of editing commands has been processed, there is the possibility that the computer needs to take further action because there is now a new service at the head of the itinerary. This will always be the case when the editing commands create a new itinerary where none previously existed, but can also be the case when an existing itinerary is edited. Where there is a new service at the head of the itinerary, the computer may need to transfer the group from its current virtual queue (if any) to the virtual queue for the service now at the head of their itinerary.

At step 166, the computer tests whether the group is currently either called to a service (but has not yet arrived) or actually at a service. If so, the computer need take no further action. The group will be called to the service now at the head of their itinerary when they leave the present service.

However, if the group is not currently called or at a service, the computer checks at step 168 whether the service at the head of their itinerary has been changed by the editing commands. If so, at steps 170 and 172, the computer transfers the group from the virtual queue they are currently in (if any) to the virtual queue for the service now at the head of their itinerary.

Optionally, the system could also support the creation of an itinerary prior to visiting the location. In such a case, the group would create the itinerary on the Internet, using a standard web browser and visiting a website associated with the location. This website would provide the same facilities as an in-location itinerary management station, with the same ‘look and feel’. When using the website to create an itinerary prior to visiting the location, the group would enter the full number of the mobile phone that they intend to use at the location. The system then stores both the phone number and the itinerary in its memory, with an association between the two. Subsequently, when the group registers, the system recognises that there is already an itinerary for the mobile phone number (at step 116 in FIG. 5). It then retrieves this itinerary and associates it with the group identification code.

Whenever an itinerary is first established—whether following registration by using the mobile phone or an in-location itinerary management station, or during registration by retrieving an itinerary previously created at the website—the system immediately adds the group to the virtual queue for the first service in that itinerary.

Enqueuing a Group for a Service

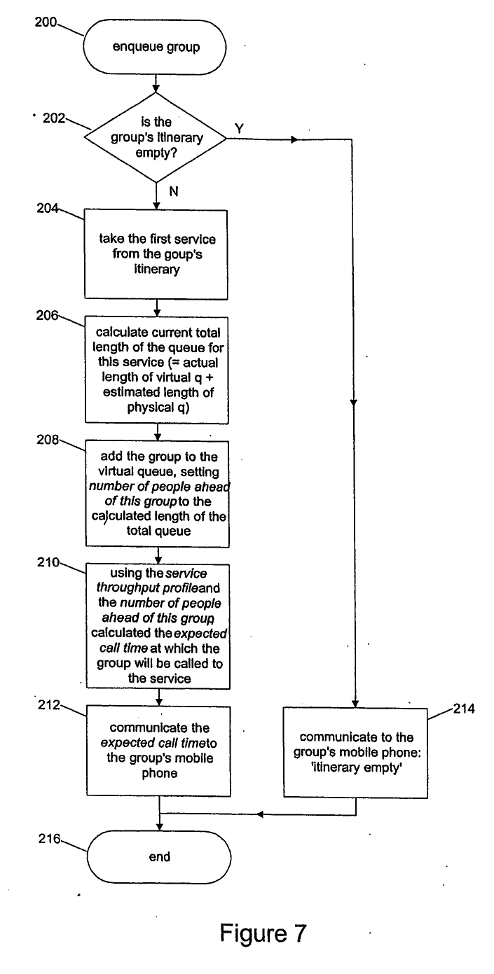

The system's actions when adding a group to the virtual queue for a service 14 are illustrated in the flowchart of FIG. 7. This sequence of actions is initiated in two distinct situations: first, when an itinerary is first established; and second, when the group leaves one service in their itinerary and must therefore be added to the virtual queue for the next service in their itinerary.

At step 202, the queue management system computer 32 tests whether the group's itinerary is now empty—a situation that will arise if the group has just left a previous service 14 and that service was the last one in their itinerary. If so, at step 214, the computer sends a warning of this condition to the group's mobile phone. If the group wishes to continue using the virtual queuing system they must then establish a new itinerary.

If the itinerary is not empty, at step 204 the computer selects the service that is now at the head of the itinerary. At step 206 it calculates the total length of the current queue for that service—that is, the length of the physical queue for the service plus the length of the virtual queue. Since the virtual queue is stored within the computer itself, an accurate figure for its length is already available. However, for the physical queue length the computer uses an estimate. This estimate is maintained by the system operators. Prior to the start of the day, and interacting with the computer via its operator station 40, the operators establish a physical queue length profile for each service that has virtual queuing. These profiles are held within the computer 32. Based on historical records and other relevant information, each such profile shows for various periods throughout the day the expected length of the physical queue for that service. Having initially established this profile, the system operators are responsible for maintaining that profile within acceptable bounds of accuracy throughout the day. In order to do this, they periodically monitor the actual length of the physical queue. Where there is a significant discrepancy, they update the physical queue length profile for the service by modifying the estimate for any future period during the day.

So at step 206 the computer calculates the current total queue length by adding the known length of the virtual queue and the estimated length of the physical queue. At step 208 the computer sets the number of people ahead of this group (held in the computer's memory 36) to be this calculated total, thus recording the group's current position in the total queue, and adds the group to the virtual queue for the service.

At step 210 the computer then calculates the time at which the group is expected to reach the head of the total queue, which is also the time at which the system will call the group to the service. In Performing this calculation the computer uses a service throughput profile that is stored in its memory 36. This shows, for various periods throughout the day the expected throughput of the service, in terms of number of people served. For example, the profile might show that between 08h00 and 12h00 the service throughput is 3000 people per hour, that between 12h00 and 14h00 it is 2000 people per hour, and so on. Again this profile is established and maintained by the system operators, using historical records, the known characteristics of the service, planned service staffing levels and other such relevant information.

Having calculated the time at-which the group is expected to be called to the service, at step 212 the computer communicates this time to the group's mobile phone 48, thus giving them notification of the likely wait. However, this quoted time is only an estimate—the actual time of call could be impacted by unplanned events such as service breakdown.

Progressing the Virtual Queue

Once a group has been added to a virtual queue, the system progresses the group through the queue for that service and eventually calls the group to the service.

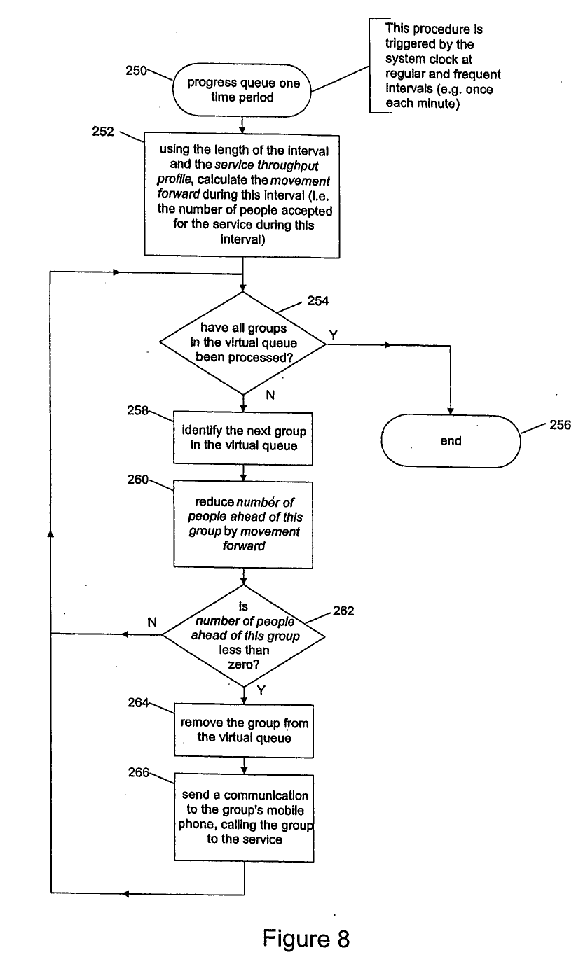

The procedure for progressing a virtual queue is illustrated in the flowchart of FIG. 8. This procedure is triggered by the queue management computer's system clock 38 at regular and frequent intervals, say once each minute.

As shown in the flowchart, at step 252 the computer first calculates the number of people who will have gained access to the service during the interval that has just expired. This calculation uses the service throughput profile. For example, if the interval is one minute and the service throughput profile shows that the current throughput rate of the service is 3000 people per hour, then the computer calculates that 50 people (=3000/60) will have gained access during the interval. The computer stores this figure in its memory as the movement forward for the queue during the interval.

The computer then works through all groups in the virtual queue. At step 254 it tests whether all groups in the queue have been processed. If the virtual queue is empty, this condition will immediately be true, and no further action is required. However, if the virtual queue is not empty, this condition will be false on the first iteration but true on a subsequent iteration when the computer has worked through all groups in the queue.

Where there are still groups to be processed, at step 258 the computer identifies the next group in the queue. At step 260 it reduces the number of people ahead of this group (stored in its memory) by the movement forward—thus recording the forward progress of the group in the queue. Then at step 262 the computer tests whether the number of people ahead of this group is now less than zero. If not, the group has not yet reached the head of the queue and the computer returns to step 254 to continue processing the remaining groups in the queue. However, if the number of people ahead of this group is less than zero, the group has reached the head of the total queue for the service. So at step 264 the computer removes the group from the virtual queue and at step 266 sends a summons signal to the group, in the form of a communication to the group's mobile phone, calling them to the service. The computer then returns to step 254 to test whether there are further groups to be processed.

Processing Arrival at a Priority Access Point

Having received a communication calling them to the service, the members of a group make their way to the service 14 and, specifically, to the service priority access point 20 that is reserved for people who have been through the virtual queue.

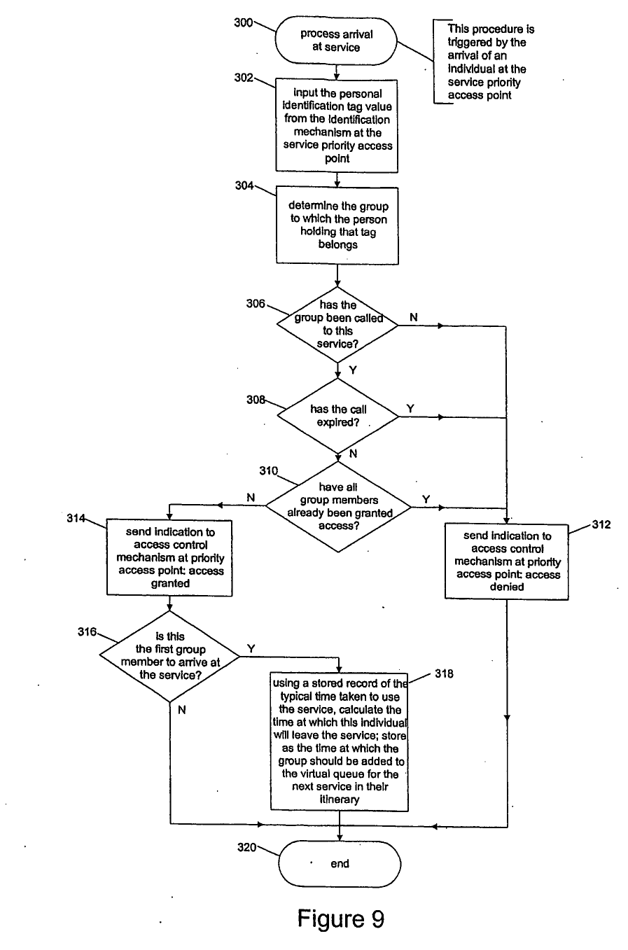

In order to gain access at the priority access point 20, group members must present their personal identification tags 54 to an identification and access control mechanism 22. In this first embodiment, this mechanism takes the form of an automatic turnstile with a barcode reader, interfaced to the queue management system computer through an industry-standard local area network. Presentation of an identification tag at an identification and access control mechanism triggers the queue management computer to execute the procedure shown in FIG. 9.

At step 302, the queue management system computer inputs the value of the individual's personal identification tag 54 from the identification mechanism 22 at the priority access point 20. Using that value, and the associations established in its memory at the time of registration, the computer determines at step 304 the group to which that individual belongs.

The individual should only be granted access if three conditions apply:
the group must have been called to this service
the call must not have expired. Each call has a limited period of validity—which might be, say, 30 minutes—and the individual must report at the priority access point within this validity period.
it must not be the case that all group members have already been granted access. So if, for example, the group size is three, and three group members have already gained access, then any further attempt is denied. (This condition is needed to prevent abuse, for example by people removing their wristbands and passing them to others.)

At steps 306, 308 and 310 the computer therefore checks these three conditions. Should any of the checks fail, at step 312 the computer sends an indication to the access control mechanism that access should be denied. This indication has the effect of leaving the turnstile locked and perhaps lighting an appropriately coloured LED to indicate the denial. Conversely, where all checks are passed, at step 314 the computer sends an indication to the access control mechanism that access should be granted. This indication unlocks the turnstile for one person to pass through and perhaps also lights an appropriately coloured LED to indicate that access is granted.

Where access is granted, the computer then checks at step 316 whether this individual is the first member of the group to arrive at the priority access point. If so, at step 31 8 it uses a stored record of the typical time taken to use the service to calculate the time at which this individual will leave the service. It then stores this calculated time in its memory as the time at which the group should be added to the virtual queue for the next service in their itinerary.

Group members are not constrained to all report to the priority access point together. They can report individually, perhaps with some significant time period between them, and the system will grant them access individually. Equally, it is not a requirement for all group members to actually use the service—some members may choose to abstain. If all members abstain, so that none arrives within the call validity period, the system detects this. When the validity period expires, the system then sends a communication to the group's mobile phone, notifying them of the expiry, and then adds the group to the virtual queue for the next service in their itinerary.

Change in the Service Throughput Profile

The operators of the virtual queuing system are required both to establish the service throughput profiles for the various services 14 prior to the start of the day and to maintain those profiles throughout the day. So if, for example, the throughput rate of a service is lower than expected—perhaps because of a staffing shortfall—the operators will edit the throughput profile for that service to reflect this lower throughput rate. Or if a service suffers a complete breakdown, the operators will immediately set its throughput rate at zero. They will then enquire about the likely time required to repair the service, and will again edit the profile to show a throughput of zero for the expected duration of the repair period. But should the repair take less time than expected, the operators can yet again edit the profile to show that the service is now back to normal. So some edits to the profile will show a decrease in the throughput of the service, while others will show an increase.

A change to a service throughput profile can invalidate the expected call time given to a group on joining the virtual queue for that service. If the throughput rate has decreased, the group will be called to the service later than the time originally quoted. Conversely, if the throughput has increased, the group will be called earlier. In either case the group may need to be warned.

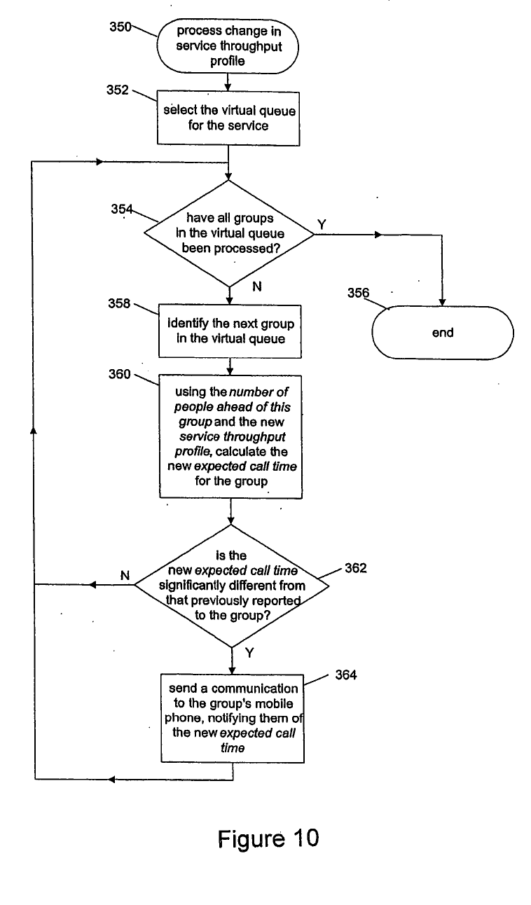

The system's actions when a service throughput profile is changed are shown in the flowchart of FIG. 10.

As shown in that flowchart, at step 352 the queue management system computer selects the virtual queue for the service whose throughput profile has changed. At step 354 it tests whether all groups in the queue have been processed. If the virtual queue is empty, this condition will immediately be true, and no further action is required. However, if the virtual queue is not empty, this condition will be false on the first iteration but true on a subsequent iteration when the computer has worked through all groups in the queue.

Where there are still groups to be processed, at step 358 the computer identifies the next group in the queue. At step 360 it calculates a new expected call time for the group. This calculation is based on the number of people currently ahead of the group in the total queue for the service (as recorded in the computer's memory) and the revised service throughput profile.

The calculation yields a new expected call time. At step 362 the computer tests whether this new time is significantly different from the time last reported to the group—that is, whether the new time is within, say, 2 or 3 minutes of the previously reported time. Where the new time is not significantly different from the previously reported time, the computer takes no further action for this group. However, where the new expected call time is significantly different from that previously reported, at step 364 the computer sends a communication to the group's mobile phone informing them of the new time. In either case the computer then returns to step 354 to process the next group in the virtual queue. Once all groups in the virtual queue have been processed, the processing of the change in the service throughput profile is complete.

Subsequently, when progressing the virtual queue, the system will of course use the revised service throughput profile, so that the group will be called to the service at the time last reported to them.

A pause in an Itinerary

At some point during its itinerary a group may wish to have a pause whereby it will not be called to any service for a specified period of time. Such a pause might be employed, for example, to allow the group to break for lunch. In the absence of a pause, the group could be forced either to curtail its lunch break or to miss the validity period of the call to the next service in their itinerary.

Optionally the system therefore supports a special itinerary entry named pause. A group can insert a pause at any point in their itinerary, along with a specified duration. So an itinerary might specify, for example, that the group wishes to use service A, then pause for sixty minutes, and then use service B. The meaning of this specific pause is that the group wishes at least 60 minutes to elapse between their leaving service A and their being called to service B. They still want to progress through the virtual queue for service B but they do not want to be called to that service in less than an hour.

To support this pause option, the system employs a special pause queue for each service that is effectively an extension of the normal virtual queue for the service. This pause queue is entirely internal to the system and invisible to groups using the system.

The system begins its processing of a pause itinerary entry at the time that the group leaves the service preceding that pause. So in the example itinerary of service A; pause 60; service B

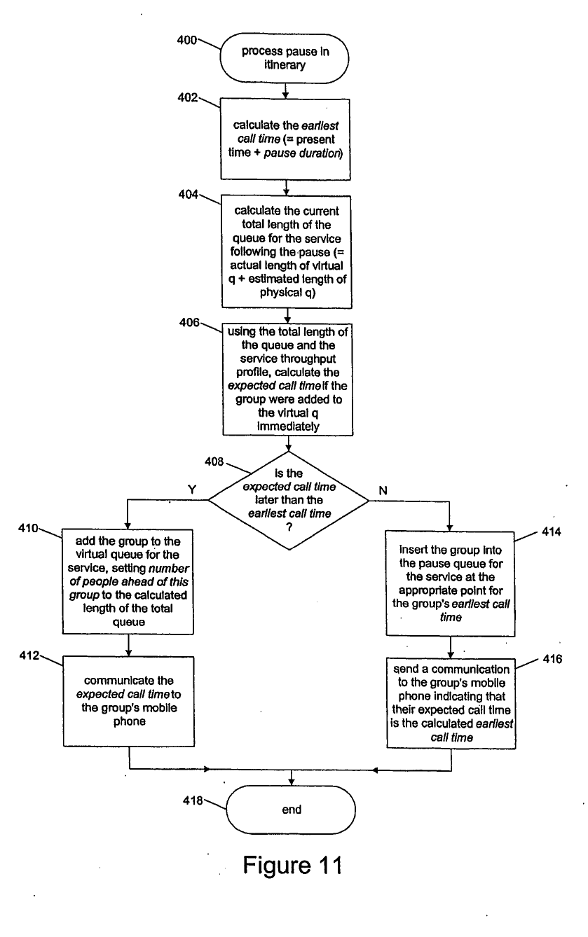

the system begins processing the pause at the time the group leaves service A. In the absence of the pause, the system would of course simply add the group to the virtual queue for service B. However, because of the pause, special action is required, as illustrated in the flowchart of FIG. 11.

At step 402 the queue management system computer calculates an earliest call time for the group, which is simply the present time (taken from the system clock 38) plus the pause duration specified in the group's itinerary. So if the group leaves service A at 12h43, the earliest call time is 13h43 (=12h43+60 minutes). The computer stores this earliest call time for the group in its memory.

At steps 404 and 406 the computer examines the service following the pause in the group's itinerary (e.g. in the example already given, it examines service B). It calculates the current total length of the queue for this service and then the group's expected call time in the normal way, as if the group were now joining this virtual queue with no intervening pause. At step 408 it then tests whether this expected call time is later than the earliest call time. If so, at step 410 the computer simply adds the group to the virtual queue for the service and, at step 412, sends a communication to the group's mobile phone informing them of the expected call time.

However, if the expected call time is earlier than the earliest call time, at step 414 the computer instead inserts the group into the pause queue for the service. This pause queue is maintained in ascending order of earliest call time, and the computer inserts the group into this queue in the appropriate position. At step 416, the computer then sends a communication to the group's mobile phone informing them of their expected call time, which in this case is the calculated earliest call time. Processing of the pause item in the group's itinerary is now complete.

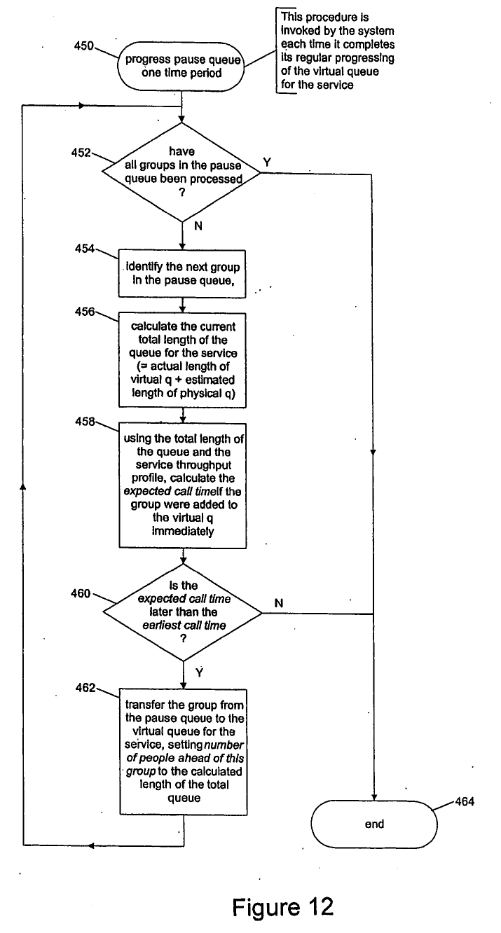

Subsequently, each time the system progresses the virtual queue for the service one time interval, it also examines the pause queue. Having processed all groups in the virtual queue (as shown in the flowchart of FIG. 8), it then works through the pause queue, as shown in the flowchart of FIG. 12.

At step 452 the queue management system computer tests whether all groups in the queue have been processed. If the pause queue is empty, this condition will immediately be true, and no further action is required. However, if the pause queue is not empty, this condition will be false on the first iteration but could become true on a subsequent iteration if all groups are transferred from the pause queue to the virtual queue.

Where there are still groups to be processed, at step 454 the computer identifies the next group in the queue. At steps 456 and 458 it calculates the current total length of the queue for this service and the group's expected call time in the normal way, as if the group were now joining the virtual queue for the service. At step 460 it then tests whether this expected call time is later than the group's earliest call time (as previously calculated and stored in the computer's memory).

If the expected call time is later than the earliest call time, then at step 462 the computer transfers the group from the pause queue to the virtual queue, setting the number of people ahead of this group to the length of the total queue as calculated at step 456. It then returns to step 452 to continue the processing of any remaining groups in the pause queue.

However, if at step 460 the expected call time is not later than the earliest call time, the processing of the pause queue is complete. The current group is simply left in the pause queue. Further, if there are any other groups behind the current group in the pause queue, their earliest call times must be later than that of the current group, so they too must be left in the pause queue. Hence no further processing of the pause queue is required.

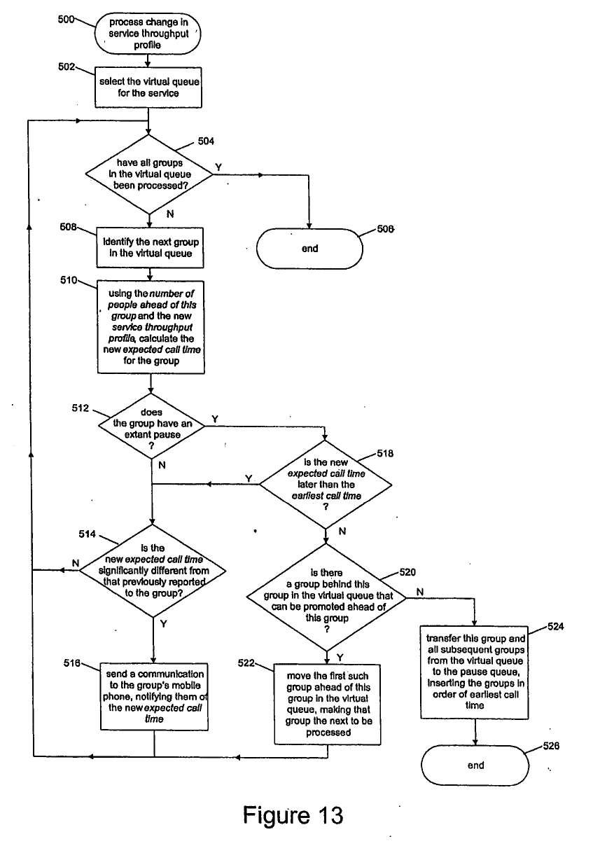

A group in the virtual queue that has an extant pause can of course be impacted by a change in the service throughput profile. Specifically, if the service throughput rate increases there is a danger of the group being called to the service before their earliest call time. Thus, where the pause option is supported, the basic procedure for processing a change in the service throughput profile that was illustrated in FIG. 10 must be extended. The extended procedure is shown in the flowchart of FIG. 13.

At step 502 the queue management system computer selects the virtual queue for the service whose throughput profile has changed. At step 504 it tests whether all groups in the queue have been processed. If the virtual queue is empty, this condition will immediately be true, and no further action is required. However, if the virtual queue is not empty, this condition will be false on the first iteration but could become true on a subsequent iteration if there are no groups in the virtual queue that must be transferred to the pause queue.

Where there are still groups to be processed, at step 508 the computer identifies the next group in the queue. At step 510 it then calculates a new expected call time for this group, using the number of people ahead of this group (stored in the computer's memory) and the new service throughput profile.

At step 512 the computer then tests whether this group has an extant pause (i.e. whether there was a pause item in the group's itinerary immediately prior to the present service). If not, the computer simply processes the group in the normal way, as previously illustrated in FIG. 10. Thus at step 514 the computer tests whether the new expected call time is significantly different from the time last reported to the group. Where the new time is not significantly different from the previously reported time, the computer takes no further action for this group. However, where the new expected call time is significantly different from that previously reported, at step 516 the computer sends a communication to the group's mobile phone informing them of the new time.

Where at step 512 the group does have an extant pause, the computer tests whether the new expected call time is later than the earliest call time. If this is the case, then there is no danger of the group being called before its earliest call time, and the computer continues to process the group in the normal way at step 514.

However, if the new expected call time is earlier than the earliest call time, the group cannot be left in its current position in the virtual queue, since it would then be called to the service before its pause duration had expired. So if possible the computer must move the group back in the virtual queue to a point where the expected call time will be later than the earliest call time.

In order to do this, the computer tests at step 520 whether there is a group behind this group in the virtual queue that can be promoted ahead of this group. A group can be so promoted if either it has no extant pause (i.e. there is no reason to delay the group's progress) or if it has an extant pause but its earliest call time is earlier than that of the current group. If there is a group that can be promoted, then at step 522 the computer moves the first such group to the position immediately ahead of the current group in the virtual queue, thus moving the current group back one place. It also makes this group that has been promoted the next group to be processed, so that it becomes the group that will next be identified at step 508 and processed in the next iteration. Having been moved back in the queue, the current group will be re-considered at the subsequent iteration, when its calculated expected call time will be slightly later.

If at step 520 there is no group behind the current group that can be promoted, then the current group and all groups behind it cannot remain in the virtual queue. All these groups have an extant pause and if left in the virtual queue would be called to the service before their earliest call time. Thus at step 524 the computer transfers all these groups from the virtual queue to the pause queue, inserting them in order of earliest call time. This then completes the processing of the change in the service throughput profile.

Where a change in the throughput profile increases the throughput of the service, the procedure described above moves groups with an extant pause back in the virtual queue as necessary to the fir point where their expected call time is later than their earliest call time. If necessary, the group is moved out of the virtual queue entirely and into the pause queue—they will then be placed back into the virtual queue at an appropriate time as that queue progresses. However, where a change in the service throughput profile delays the service, the computer takes no special action for groups with an extant pause. Those groups simply suffer the increased delay, just like all other groups in the virtual queue.

The Service No-Show Factor

A known issue with any form of virtual queuing is that of no-shows, whereby individuals or groups join a virtual queue but subsequently do not report to the service after reaching the head of the queue. In the case of the present invention, the no-show rate is likely to be low during the course of the day but to rise towards the end of the day, as groups that still have non-empty itineraries leave the location without visiting the services that remain in their itinerary.

While it would be possible to simply ignore such no-shows, this would compromise the accuracy and fairness of the virtual queuing system. Suppose that towards the end of the day the no-show rate for a virtual queue was significant. Under a virtual queue management system as described thus far, those groups remaining in the virtual queue would not progress any more quickly. Rather, the service ‘slots’ left unclaimed by no-shows from the virtual queue would be taken up by people from the physical queue. Thus the physical queue would progress at the expense of the virtual queue, and groups from the virtual queue would be forced to wait for longer than they should.

To avoid this effect, the system optionally can adjust for no-shows from the virtual queue. In order to do this, it divides the day into a sequence of fixed-length timeslots, each of duration of, say, 15 minutes. For each virtual queue, it then calculates the actual no-show factor for each of these timeslots as the day progresses. Since the system itself calls groups to the service and subsequently monitors the arrival of groups at the service priority access points, it is able to calculate this no show factor for a given timeslot with complete accuracy as soon as the validity periods for all calls issued during that timeslot have expired.

Once the system has established the actual no-show factors for a few successive timeslots, it uses a simple mathematical extrapolation algorithm to predict the expected no-show factor for future timeslots. Use of such an algorithm of course assumes that the no-show factor changes smoothly and progressively rather than randomly or suddenly. Experience shows that this assumption is normally valid.

These expected no-show factors are then used in calculating the expected call time for a group joining the queue, or for a group already in the queue when a change in the throughput profile causes the expected call times to be re-calculated. Specifically, this calculation entails viewing each group not as having some overall place in the combined queue for the service, but rather as having a known number of people ahead of them in the physical queue and then a known number of people ahead of them in the virtual queue. In calculating the expected call time, the system first uses the service throughput profile to calculate a time at which the number of people ahead of this group in the physical queue will have gained access to the service, under the artificial assumption that the physical queue takes precedence over the virtual queue. This calculation yields a time known as the physical clearance time. Then, using this physical clearance time as the start point, and again consulting the service throughput profile, the system calculates the time at which the number of people ahead of this group in the virtual queue will have accessed the service. But for this second calculation the system applies the expected no-show factors that pertain after the physical clearance time. So if the number of people ahead of this group in the virtual queue is 500 but the expected no-show factor is 40%, the system calculates the time by which just 300 people will have gained access, rather than all 500. The result of this second calculation then provides the expected call time that is reported to the group.

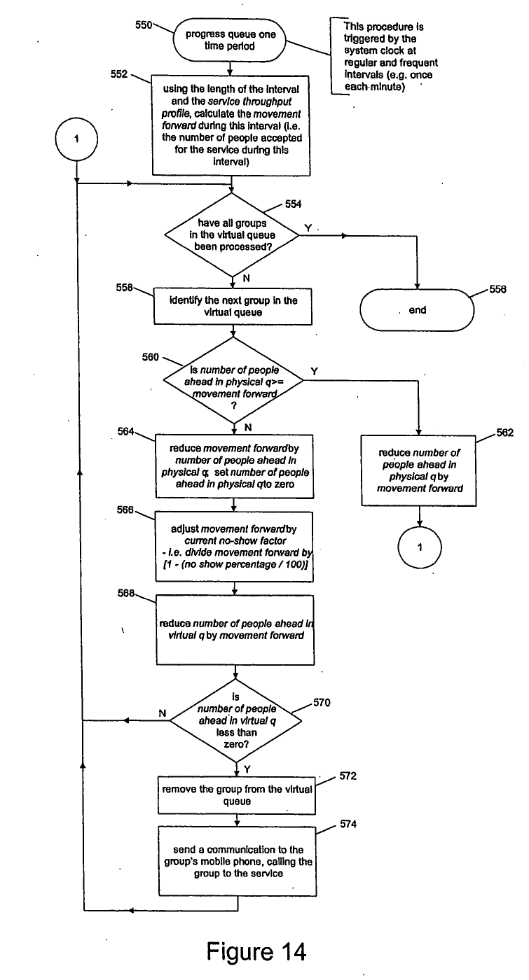

When progressing the queue for a service, the system employs this same approach of distinguishing between the physical queue and the virtual queue. Thus the flowchart of FIG. 8 is replaced by the amended flowchart of FIG. 14.

Steps 552 through 558 in the flowchart are identical to the corresponding steps of FIG. 8. Thus at step 552 the queue management system computer first uses the service throughput profile to calculate the number of people who will have gained access to the service during the interval that has just expired. The computer stores this figure in its memory as the movement forward for the queue during the interval.

The computer then works through all groups in the virtual queue. At step 554 it tests whether all groups in the queue have been processed. If the virtual queue is empty, this condition will immediately be true, and no further action is required. However, if the virtual queue is not empty, this condition will be false on the first iteration but true on a subsequent iteration when the computer has worked through all groups in the queue.

Where there are still groups to be processed, at step 558 the computer identifies the next group in the queue. Then at step 560 it tests whether the number of people ahead in physical queue (as maintained in the computer's memory) is greater than or equal to the movement forward. If so, at step 562 the computer reduces the number of people ahead in physical queue by movement forward and then returns to step 554 to continue processing the remainder of the queue.

If at step 560 the number of people ahead in physical queue is less than the movement forward, then at step 564 the computer reduces movement forward by number of people ahead in physical queue and then sets number of people ahead in physical queue to zero. The first time this step is performed for a given group, it has the effect of ‘clearing’ the last few people remaining ahead of the group in the physical queue. On all subsequent occasions—since the number of people ahead in physical q has now been set to zero—the step has no effect.

At step 566 the computer is now dealing only with those groups ahead of this group in the virtual queue, not with the physical queue. It therefore adjusts the movement forward by the current no-show factor. Thus, for example, if the actual movement forward during the period is 30 people, but the no-show factor is 40%, the computer adjusts the movement forward to 50. It is through this adjustment that the computer compensates for no-shows from the virtual queue.

At step 568, the computer then reduces number of people ahead in virtual q by the (adjusted) movement forward. It then tests at step 570 whether the number of people ahead in virtual q is less than zero. If not, the group has not yet reached the head of the total queue and the computer returns to step 554 to continue processing the remaining groups in the queue.

However, if at step 570 the number of people ahead in virtual q is less than zero, the group has reached the head of the total queue. So at step 572 the computer removes the group from the virtual queue and at step 574 sends a communication to the group's mobile phone calling them to the service. The computer then returns to step 554 to test whether there are further groups to be processed.

By applying this procedure the system compensates for no-shows from the virtual queue and thereby remains fair—where a group joins the virtual queue for a service at the same time that another group joins the physical queue, those two groups will obtain access to the service at approximately the same time.

Generating Registration Codes and Producing Registration Packs

A first embodiment of the main virtual queuing system has now been fully described. However the description thus far has not considered the generation of registration codes or the production of registration packs.

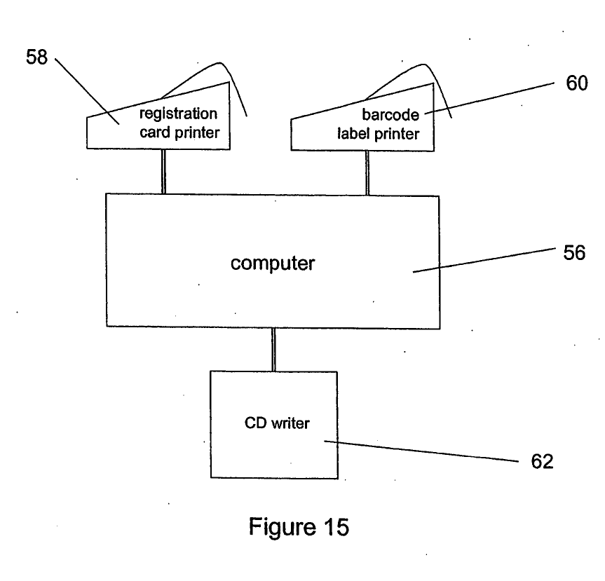

In this first embodiment the registration codes are generated by a registration pack production system that is distinct and separate from the main virtual queuing system. At the heart of this system is a pack production computer system, as shown in FIG. 15. As shown in the figure, this system consists of a computer 56 equipped with a registration card printer 58 and a barcode label printer 60 for printing the barcode labels that are pasted onto the wristbands included in registration packs. The computer also has a CD writer 62.

As part of producing each registration pack, this system generates the unique registration code that will feature on both the registration card and, in barcode form, the wristbands contained in that pack. The packs are produced in batches of, say, 200 and each batch contains packs for just one size of group. So there are separate batches for groups of just one individual, for groups of two, and so on.

On completion of each batch, the production system writes a CD with both the group size and all the registration codes used in that batch. Then, immediately before releasing the batch of registration packs for use at a location, the CD is loaded into the virtual queue management system computer.

Within its memory 36 the virtual queue management system computer 32 holds several sets of registration codes that are currently valid, with a separate set for each supported group size. When a new CD is loaded, the computer first reads the group size and then reads all the registration codes from the CD, adding those codes to the appropriate set of valid codes. Subsequently, when a group registers using one of these codes, the system is able to determine both that the code is valid and the size of the group holding the code. It then removes that particular code from the set.

### A Second Embodiment

In the first embodiment described above, the information carrier bearing the group registration code and the group's personal identification tags 54 are all physical members contained within the same registration pack 50, and the registration code is such that the system can determine the tag values from the registration code.

In a second embodiment, the registration code does not have this property of allowing the system to determine identification tag values. This second embodiment may be convenient in the case where the identification tags take the form of RFID chips, and is essential where identification based on biometric data is used.

Given that tag values cannot be determined from the registration code, the central principle of this second embodiment is a tag recognition or creation step prior to (or simultaneous with) group registration.

Thus in this embodiment a group obtains its registration pack 50 in the normal way. This pack contains a card 52 with the group registration code, possibly in both printed and machine-readable form. If necessary it also contains personal identification tags 54 for each group member. (Where biometric data is used, the tags need not—and indeed cannot—be included in the pack since the identifying details are biometric characteristics and in this instance the biometric characteristics are scanned into the computer system to create virtual tags within the computer).

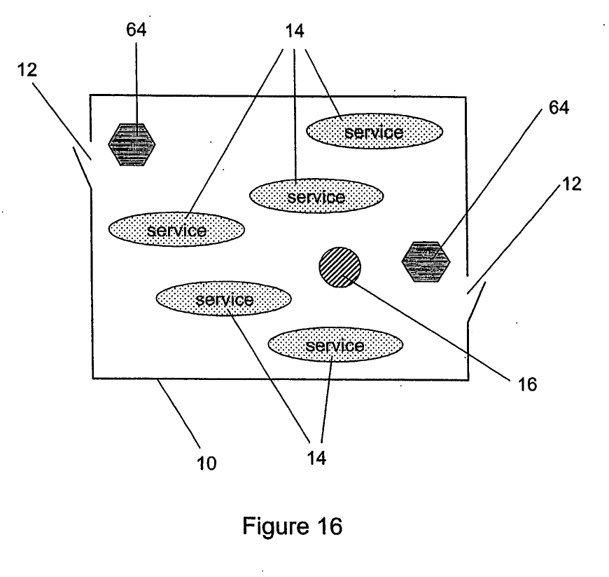

Having obtained its registration pack 50, and before registering with the virtual queuing system, the members of the group must go together to a tag recognition or creation point. As shown in FIG. 16—which illustrates a location 10 with tag recognition points—there can be a number of such points 64 that could be conveniently located, for example close to the location entrances 12.

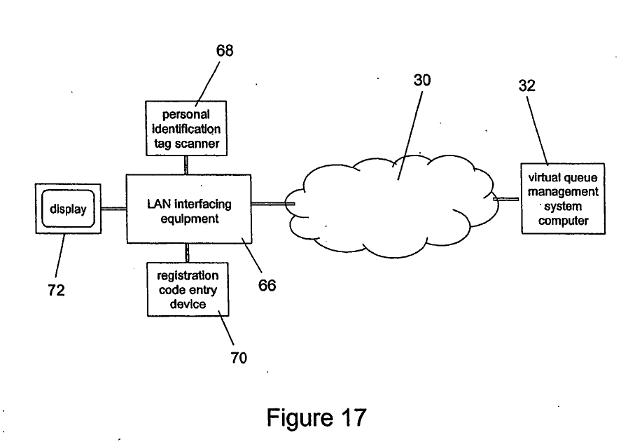

A more detailed view of a tag recognition point 64 is given in FIG. 17. As shown in the figure, each point is interfaced to the virtual queue management system computer 32 through the local area network (LAN) 30. Each point consists of LAN interfacing equipment 66, a personal identification scanner 68, a registration code entry device 70 (such as a registration card reader or a keypad), and some form of display 72 for presenting instructions and error messages. Through the LAN 30 and the LAN interfacing equipment 66, the virtual queue management system computer 32 is able to access the personal identification scanner 68, the registration code entry device 70 and the display 72.

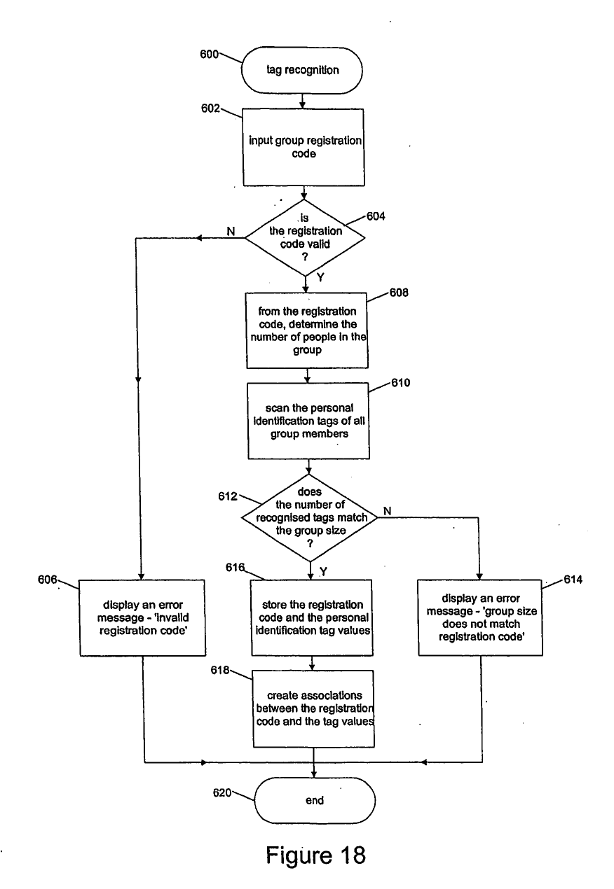

At the tag recognition point 64 the group enters its registration code into the registration code entry device 70 and this action triggers the procedure shown in FIG. 18.

As shown in the figure, at step 602 the queue management system computer inputs the group's registration code from the registration code entry device 70. At step 604 the computer checks whether the registration code is valid. If not, at step 606 the computer displays a message on the display 72 indicating to the group that the registration code is invalid.

Having determined at step 604 that the registration code is valid, at step 608 the computer uses the registration code to determine the number of people in the group. Then at step 610 it scans the personal identification tags or biometric features of all group members, using scanner 68, and in the latter instance generates a series of corresponding virtual tags stored within the system computer memory 36. At step 612 it then tests whether the number of recognised tags matches the group size. If not, at step 614 the computer displays an error message on the display 72 indicating that the number of recognised tags does not match the group size indicated by the registration code. The group must then correct the mis-match and re-initiate the tag recognition procedure.

Where the registration code is valid and the number of tags matches the group size, the computer proceeds to step 616 where it stores the registration code and the identification tag values. Then at step 618 it creates associations between the registration code and the tag values, and the tag recognition procedure is complete.

Biometric tags are of course unique to the individual, so in this case the tag values for the various group members will all be different. With other forms of tag, the values of the group members could all be the same. But in either case, the system stores the tag values for all members of the group.

With RFID scanning the tags for the entire group can be scanned within a fraction of a second and there is little danger of secondary queues developing. Equally, facial recognition technology has already reached the stage whereby several people can be scanned in a fraction of a second. However, with retina or fingerprint scanning there would be some danger of secondary queues which could only be avoided by providing a sufficient number of recognition points.

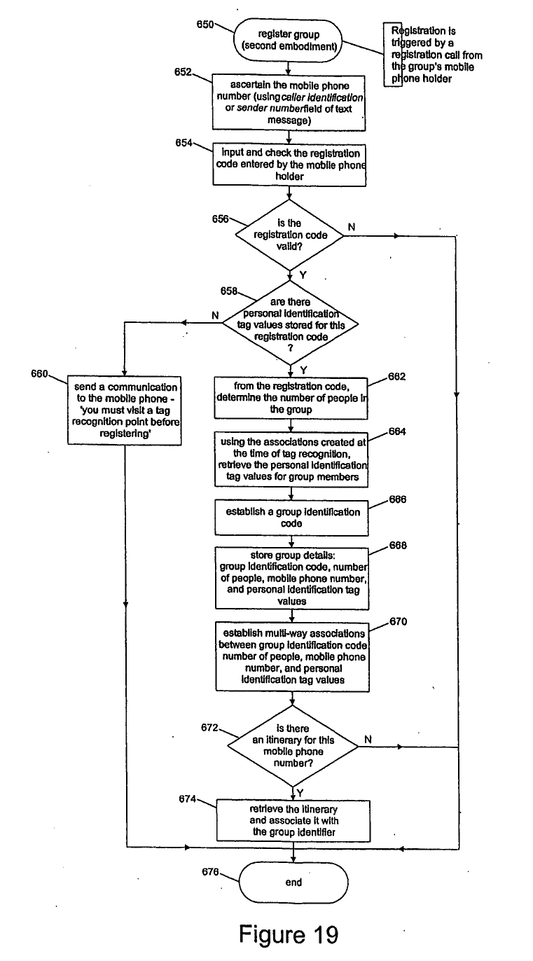

Having visited a tag determination point 64, the group can register with the queuing system in the normal way, by means of a communication from their mobile phone that specifies the group's registration code. However—as shown in the flowchart of FIG. 19—rather than determining the personal identification tag values from that registration code, the system uses the code to retrieve the tag values that were stored when the group was at the recognition point.

At step 652 the queue management system computer first ascertains the number of the mobile phone that the group is using, either through the phone network's caller identification facility or from the sender number field of the text message.

At step 654 the computer inputs and checks the registration code entered on the group's mobile phone. At step 656 it then checks whether the registration code is valid. If not, the computer takes no further action.

Given a valid registration code, the computer checks at step 658 whether there are identification tag values stored in its memory and associated with that registration code. If not, at step 660 the computer sends a communication to the mobile phone indicating that the group must visit a tag determination point before registering.

If at step 658 there are identification tag values associated with the registration code, then the computer proceeds to step 662 where it uses the registration code to determine the number of people in the group. Then at step 664, using the registration code and the associations created at the time of tag recognition, the computer retrieves the personal identification tag values for the group members.

The remaining steps in FIG. 19 are identical to the corresponding steps in the first embodiment. Thus at step 666 the computer establishes an identification code for the group. At steps 668 and 670 the computer stores in its memory, and establishes multi-way associations between, the various group details—the group identification code, the size of the group, the group's mobile phone number, and the values of the personal identification tags of the group members. Then at step 672 the computer checks whether there is already an itinerary stored in its memory for the group's mobile phone number. If so, at step 674 the computer retrieves that stored itinerary and associates it with the group identification code. This completes the group's registration.

Subsequently, when a group member reports at a priority access point 22, the identification mechanism scans that member's identification tag. Where group members have their own individual tags (as is the case with biometric tags), the system grants access on an individual basis—each group member is granted access at most once. Where group members share the same tag value, the system grants access on the basis of group size—it will grant access to at most N people, where N is the size of the group.

### Alternative Embodiments

Both embodiments described above admit a number of possible variants. These will be described below.

Personal Identification Tags

In the first embodiment described above, the values of the personal identification tags held by the group members are all the same as the group's registration code. However, this is not a fundamental requirement. The tags could have any value that is unique to the group and that the system can readily calculate from the registration code. When the group registers, the system then performs this calculation to obtain the tag values.

Further—and as has already been illustrated with biometric tags in the second embodiment—it is not a requirement in the first embodiment that all group members share the same identification tag value. Group members can have their own individual tag values, which could be useful if the tag values are used for other purposes within the location besides virtual queuing. The only constraint is that it must be possible to calculate all the group's tag values from the single registration code. Thus one simple arrangement would be to supplement the registration code with a sequential group member number (e.g. AXPBYQND/2) but other more complex arrangements are also possible.

Where individual tag values are employed, the system can grant access at a service priority access point on an individual basis rather than on the basis of group size.

In both the first and second embodiments, each group member has a personal identification tag or personal characteristics that can be read by an electronic reader or scanner—perhaps a wristband with a barcode or unique biometric characteristics. Possession of a tag or the use of features that can be scanned provides for convenient access at service priority access points and also provides tangible evidence of right of access in case of any possible dispute. However, while it is desirable for identification tags to take a form that can be scanned, it is not strictly essential. Group members can simply be given their tag values in a human-readable form—matching the content of virtual tags that will be created in the system computer 32 during registration—and then required to provide the tag value at the service priority access point. They could do this, for example, by entering the value into a keypad interfaced to the virtual queuing system. Or they could quote the value to a human gatekeeper who would enter the value on their behalf. With such arrangements, the registration pack would simply provide a printed list of the identification tag values.

In another alternative embodiment, the registration pack would not include any form of personal identification tags, either machine-readable or human-readable. Instead, the tag values would be sent to the group's mobile phone shortly after registration. This message could be human-readable only, in which case each group member would enter or quote the tag value at service priority access points as described above. Alternatively, the tags could take the form of barcodes included in one or more text messages, using technology such as that supplied by Mobiqa Limited of Edinburgh, Scotland. The identification mechanism at a service priority access point would then take the form of an ordinary barcode scanner, just as in the first embodiment. Of course, with this arrangement all group members must report to the priority access point together, since all their tags are held on the group's shared mobile phone.

Where identification tag values are sent to the group's mobile phone, rather than included in the registration pack, there is the further option of varying the values for each service in the group's itinerary. Thus the tag values are dynamically generated by the queuing system as required and included in the text message that calls the group to a service on reaching the head of the queue for that service. Such dynamic tag values may provide some further protection against abuse at locations where bystanders could potentially observe or overhear the identification tag values entered or quoted by group members arriving at a service priority access point.

Registration

While the preferred arrangements for registration are those described under the first and second embodiments above, many alternative arrangements are also acceptable. The only requirement is that they should allow the queuing system to gather the information needed for creating the multi-way associations between the group identification code, the group size, the mobile phone number and the personal identification tag values. As one example, rather than requiring a registration call from the group's mobile phone to the queuing system, it would be possible to provide registration stations within the location, interfaced through a standard local area network to the queuing system computer. At such a registration station, the group would first provide their registration code, perhaps by entering it at a keyboard or by inserting their registration card into a card reader. They would then use-the keyboard to enter the number of their mobile phone.

In the second embodiment, where biometric tags are used, one variant that is particularly attractive is to dispense with the registration card entirely and instead use a credit card belonging to one of the members of the group, with the card number forming the group's registration code. In this case, the group does not need to obtain any form of registration pack but instead, on entering the location, can go straight to a tag recognition or creation point. At the recognition point the group inserts the credit card into a reader and the system then reads the card number and scans the group's identification tags. The group subsequently registers by means of a phone communication that specifies the credit card number. Besides removing the need for a registration pack, this arrangement has the benefit that any required payment for use of the queuing system can be collected from the credit card, either while the group is at the tag recognition point or at the time of the registration call. (In other embodiments, abuse is prevented by requiring each group to provide a unique registration code that can only be obtained from a registration pack and by ensuring that each group can obtain at most one such pack. However, in this arrangement where a credit card number serves as the registration code, abuse is prevented by the system refusing to register any group where one or more of the biometric identification tags is the same as a group that is already registered. That is, the system will not allow one individual to be a member of two or more registered groups.)

The Priority Access Point

The only requirements on the identification and access control mechanism at a priority access point are that it should be able to read identification tags, send those tag values to the queuing system computer, and then respond to the indication from the computer by either granting or denying access. Thus the mechanism could take any of a number of forms. It could, as in the first embodiment, take the form of a tag scanner linked to an automatic turnstile. Or, as a second example, it could take the form of a human gatekeeper using a hand-held scanner. The indication from the queuing system that access should be granted or denied would then light an appropriately coloured LED on the scanner, or perhaps display a short message on an LCD screen, and the human gatekeeper then responds appropriately.

Registration Code Generation and Registration Pack Production

Just as the main virtual queuing system admits of several possible variants, so also does the registration code generation and registration pack production system.

In one variant, the registration codes are not truly random but pseudo-random, generated by a deterministic algorithm using an initial seed value. In such an embodiment, there is no need to input all the individual registration codes of a registration pack batch into the virtual queue management system computer, but only the seed used in generating the codes for that batch. This seed value could be entered at the keyboard of the virtual queue management system operator station. The virtual queue management system then uses the seed value to generate precisely the same pseudo-random registration codes as were previously generated by the registration pack production system.

Yet other embodiments could avoid any need for data transfer from the registration pack production system to the virtual queue management system, but at the expense of extra equipment at all points at which groups can obtain their registration packs and/or some integration between the virtual queuing system and the location's ticketing system. As three specific examples:
Each registration pack produced by the separate production system could have a barcode label on the outside of the pack showing both the registration code for that pack and the group size. Then the member of the location's staff who supplies that pack to a group would first scan this external barcode on a scanner interfaced to the virtual queuing system. The virtual queuing system would then add the registration code to its internal set of valid registration codes for the specified group size.
The separate production system could be eliminated entirely, and replaced by suitable printing facilities at each point of registration pack supply, interfaced to the virtual queuing system. The system would then generate registration codes and print registration pack content on demand—both barcode labels for sticking onto wristbands and a registration card with a printed registration code.
Where the location entry ticket takes a suitable form—having a unique ticket number that is machine-readable—that ticket can be used as the personal identification tag. This however requires some integration between the location ticketing system and the virtual queuing system. With such integration, the ticketing system would provide the queuing system with the ticket numbers of a group wishing to use virtual queuing, and the queuing system would respond with a dynamically-assigned registration code. This registration code would then be printed at the ticket issuing station, either onto the tickets or onto a separate registration card.

Proximity Messaging

The itinerary that the queuing system holds for each group provides some indication of the group's geographical position throughout its visit to the location. In particular, at the time of leaving a given service, the group is known to be close to the exit from that service. Equally, by the estimated time for gaining access to the next service in its itinerary, the group must make its way from that exit to the priority access point for this next service.

Optionally, the system can use this information concerning the group's physical position to send ‘proximity-based messages’ to the group's mobile telephone. These may either be sent as separate messages or be appended to the messages (shown in step 212 of FIG. 7) that notify the group of the expected call time for their next service.

Such proximity-based messages could serve a number of purposes. These include, for example:
advising the group on a recommended route between the exit of the previous service and the priority entrance point for the next service;
advising the group on points of interest along this route or close to it (e.g. displays, viewpoints, washrooms);
advising the group of places that are conveniently situated for the group to spend their time while awaiting their turn for the next service in their itinerary, such places including, for example, shops, cafes and restaurants, or minor services that can typically be obtained without any need to queue.

1-34. (canceled)

35. A queue management system for controlling the movement of a group of one or more people through a virtual queue line for a service, comprising:
registration means for registering the group, the registration means comprising an information carrier and at least one ID tag for the member(s) of the group, the information carrier bearing a registration code and the at least one ID tag including ID details for identifying the member(s) of the group, the registration means further associating the registration code with an indication of group size and uniquely with the ID details;
interface means for enabling communications to and from the group;
a processor associated with the interface means and responsive to a communication from the group including a communicator address and the registration code for generating a registration record for the group representing the group size, the ID details and the communicator address;
the processor being responsive to a further communication from the group requesting access to the virtual queue to enter the group into the virtual queue and thereafter to monitor the place of the group in the virtual queue line and to trigger a summons signal when the group approaches or reaches the head of the queue line;
the interface means being responsive to the summons signal for initiating a communication to the communicator address for summoning the group to the service; and
access control apparatus at the service for reading the at least one ID tag and for comparing the ID details with the registration record in order to evaluate whether access to the service should be permitted or prevented.

36. A queue management system according to claim 35, in which the registration means comprises a respective ID tag for each member of the group.

37. A queue management system according to claim 35, in which the at least one ID tag comprises a portable tab or band.

38. A queue management system according to claim 35, in which the at least one ID tag includes a member bearing a scannable code.

39. A queue management system according to claim 35, in which the at least one ID tag is a virtual tag stored in memory on a computer.

40. A queue management system according to claim 39, in which the ID details are in the form of biometric data.

41. A queue management system according to claim 35, in which the information carrier is a card and the registration code is an alphanumeric value.

42. A queue management system according to claim 41, in which the card is a credit card and the registration code is the credit card number.

43. A queue management system according to claim 35, in which the registration means comprise a registration pack including the information carrier and the at least one ID tag.

44. A queue management system according to claim 35, in which the registration means comprise at least one registration station.

45. A queue management system according to claim 35, further comprising a personal communicator for the communication of audio or visual messages between the group and the interface means.

46. A queue management system according to claim 35, in which the processor is arranged to track the progress of the group through the virtual queue line by periodically noting the reduction in the number of people in the virtual queue line ahead of the group.

47. A queue management system according to claim 35, in which the processor comprises means for calculating a movement forward for the virtual queue and is arranged to track the progress of the group through the virtual queue line by periodically calculating a value representing the movement forward.

48. A queue management system according to claim 35, in which the processor comprises means responsive to receipt of the further communication for initiating a timing period, means for calculating a queuing time starting from the beginning of the timing period, and means for generating an indication of an expected service entry time for the group based on a calculated value representing the queuing time.

49. A queue management system according to claim 47, in which the processor comprises a memory for storing a service throughput profile, and in which the calculating means calculates the calculated value based on the stored service throughput profile.

50. A queue management system according to claim 49, in which the service throughput profile is based on records of previous use of the service.

51. A queue management system according to claim 49, further comprising monitoring apparatus for monitoring an actual service throughput, and in which the processor is arranged to receive information from the monitoring apparatus for updating the stored service throughput profile.

52. A queue management system according to claim 47, in which the calculating means performs calculations repeatedly as the group progresses through the virtual queue and repeatedly updates the calculated value.

53. A queue management system according to claim 35, in which the virtual queue line is combined with a physical queue line and in which the processor is arranged to monitor the place of the group in the overall queue line.

54. A queue management system according to claim 35, further comprising means for storing an itinerary for the group representing visits for a plurality of services, and in which the processor is arranged to process and manage the itinerary for the group.

55. A queue management system according to claim 54, further comprising a plurality of itinerary management stations in communication with the processor for enabling the group to create, modify and input the itinerary.

56. A queue management system for controlling the movement of a group of one or more people through a virtual queue line for a service, comprising:
at least one ID tag for the member(s) of the group, the at least one ID tag including ID details for identifying the member(s) of the group, the ID details being associated with a unique registration code and a predetermined group size;
registration apparatus responsive to an input of the registration code in conjunction with a communicator address for the group for registering the group, the registration apparatus being arranged to generate a registration record for the group representing the ID details, the group size, and the communicator address;
a processor responsive to a request from the group for access to the virtual queue line for reading the registration record and entering the group into the virtual queue and thereafter for monitoring the place of the group in the virtual queue line, the processor being arranged to trigger a summons signal when the group approaches or reaches the head of the queue line;
interface means responsive to the summons signal for initiating a communication to the communicator address for summoning the group to the service; and
access control apparatus at the service for reading the at least one ID tag and for comparing the ID details with the registration record for evaluating whether access to the service should be permitted or prevented.

57. A method of queue management for controlling the movement of a group of one or more people through a virtual queue line for a service, comprising the steps of:
assigning to the group an information carrier and at least one ID tag for the member(s) of the group, the information carrier bearing a registration code and the at least one ID tag including ID details for identifying the member(s) of the group;
associating the registration code with an indication of group size and uniquely with the ID details;
in response to a communication from the group including a communicator address and the registration code, registering the group by generating a registration record for the group representing the group size, the ID details and the communicator address;
in response to a further communication from the group for access to the virtual queue, assigning the group a place in the virtual queue and thereafter monitoring the place of the group in the virtual queue line and triggering a summons signal when the group approaches or reaches the head of the queue line;
in response to the summons signal, initiating a communication to the communicator address for summoning the group to the service; and
at the service, reading the at least one ID tag and comparing the ID details with the registration record in order to evaluate whether access to the service should be permitted or prevented.

58. A method of queue management according to claim 57, comprising assigning a respective ID tag for each member of the group.

59. A method of queue management according to claim 57, comprising providing the at least one ID tag with a scannable code.

60. A method of queue management according to claim 57, comprising storing the at least one ID tag as a virtual tag in a memory on a computer.

61. A method of queue management according to claim 59, comprising scanning the ID details into the computer in the form of biometric data.

62. A method of queue management according to claim 57, in which the step of assigning at least one tag includes allocating to the group a registration pack including the information carrier and the at least one ID tag.

63. A method of queue management according to claim 57, in which the step of assigning at least one tag includes generating the at least one ID tag through a computer recognition process.

64. A method of queue management according to claim 57, comprising using a personal communicator for the communication of audio or visual messages between the group and the interface means.

65. A method of queue management according to claim 57, in which the step of monitoring comprises tracking the progress of the group through the virtual queue line by periodically noting the reduction in the number of people in the virtual queue line ahead of the group.

66. A method of queue management according to claim 57, in which the step of monitoring comprises tracking the progress of the group through the virtual queue line by periodically calculating a value representing movement forward for the virtual queue.

67. A method of queue management according to claim 57, comprising the steps of: in response to receipt of the further communication initiating a timing period, calculating a queuing time starting from the beginning of the timing period, and generating an indication of an expected service entry time for the group based on a calculated value representing the queuing time.

68. A method of queue management according to claim 66, comprising storing a service throughput profile, and calculating the queuing time based on the stored service throughput profile.

69. A method of queue management according to claim 68, in which the service throughput profile is based on records of previous use of the service.

70. A method of queue management according to claim 68, comprising receiving information concerning an actual service throughput from the service for updating the stored service throughput profile.

71. A method of queue management according to claim 67, further comprising performing calculations repeatedly as the group progresses through the virtual queue and repeatedly updating the calculated value.

72. A method of queue management according to claim 57, in which the virtual queue line is combined with a physical queue line and comprising monitoring the place of the group in the overall queue line.

73. A method of queue management according to claim 57, further comprising storing an itinerary for the group representing visits to a plurality of services, and processing and managing the itinerary for the group.

74. A method of queue management for controlling the movement of a group of one or more people through a virtual queue line for a service, comprising the steps of:
assigning at least one ID tag to the member(s) of the group, the at least one ID tag including ID details for identifying the member(s) of the group, the ID details being associated with a unique registration code and a predetermined group size;
in response to an input of the registration code in conjunction with a communicator address for the group, registering the group by generating a registration record for the group representing the ID details, the group size, and the communicator address;
in response to a request from the group for access to the virtual queue, assigning the group a place in the virtual queue line and reading the registration record and thereafter monitoring the place of the group in the queue line;
triggering a summons signal when the group approaches or reaches the head of the queue line;
in response to the summons signal, initiating a communication to the communicator address for summoning the group to the service; and
at the service, reading the at least one ID tag and comparing the ID details with the registration record for evaluating whether access to the service should be permitted or prevented.
